(19) United States
(12) Patent Application Publication
(10) Pub. No.: US 2008/0117059 A1
(43) Pub. Date: May 22, 2008

(54) Apparatus For Communicating With RFID Tag

(75) Inventors: Tsuyoshi Ohashi, Hashima-shi (JP); Mitsuo Hirota, Toyoake-shi (JP); Takuya Nagai, Nagoya-shi (JP); Yasuhisa Ichikawa, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 11/972,824

(22) Filed: Jan. 11, 2008

Related U.S. Application Data
(63) Continuation-in-part of application No. PCT/JP2006/313743, filed on Jul. 11, 2006.

(30) Foreign Application Priority Data
Jul. 12, 2005 (JP) 2005-202585

(51) Int. Cl. G08B 13/14

(52) U.S. Cl. 340/572.8

(57) ABSTRACT

An apparatus for communicating with a RFID tag comprises a housing configured to include a carry-out exit, an antenna configured to have directivity for performing radio communication with an IC circuit part of a RFID circuit element To contained in a base tape and that is provided to the housing, a tape feeding roller configured to feed the base tape and a tag label tape with print to the carry-out exit, and a storage space configured to store a RFID label discharged from the carry-out exit by the feeding roller after radio communication is performed from the antenna; in which the storage space is disposed from the antenna in a direction other than a main lobe direction thereof.

### CROSS-REFERENCE TO RELATED APPLICATION

This is a CIP application PCT/JP2006/313743, filed Jul. 11, 2006, which was not published under PCT article 21(2) in English and claims the benefits of Japanese Patent application No. 2005-202585 filed Jul. 12, 2005.

### BACKGROUND OF THE INVENTION

1. Field of the Invention

The present invention relates to an apparatus for communicating with a RFID tag configured to perform radio communication with a RFID circuit element provided to a tag medium to be fed.

2. Description of the Related Art

A RFID (Radio Frequency Identification) system configured to perform reading/writing between a small-sized RFID tag and a reader/writer (reading/writing apparatus) in a non-contact manner is known. For example, a RFID circuit element provided to a label-shaped RFID tag comprises an IC circuit part configured to store predetermined RFID tag information, and an antenna configured to transmit/receive information, connected to the IC circuit part. With such an arrangement, the reader/writer can access (read/write) the RFID tag information in the IC circuit part even if the RFID tag has become dirty or has come to be located at a position where it cannot be seen. Thus, it is anticipated that such a technique will be of practical use in a wide variety of fields such as commodity management, inspection processes, and the like.

Such a RFID tag is normally formed on a label-shaped material so as to provide a RFID circuit element thereto, and the tag label is often adhered to a target article for classifying and organizing documents and articles, for example. In this event, information related to the RFID tag information may be printed on the label separately from the RFID tag information stored internally, permitting the user to conveniently view the related information on the label. Accordingly, in prior art, there has been proposed an apparatus for communicating with a RFID tag from such a viewpoint (refer to JP, A, 2004-70784, for example).

In this apparatus for communicating with a RFID tag of prior art, a tape-shaped tag medium (label sheet) which has labels comprising RFID circuit elements (RFID elements) adhered thereon is fed out from a roll (roll unit). At the time of the feeding, print is printed on the front face of each label. Subsequently, information from an antenna part (RFID reader/writer) of the apparatus is transmitted to the fed RFID circuit element and predetermined information is written thereto. The tag labels are then cut by a cutter, thereby continuously manufacturing printed tag labels. The tag labels created in this manner are discharged to a storage space (catch tray), collected, and stored (JP, A, 2004-70784, for example).

Nevertheless, in the above-described technique of prior art, the effect of radio waves used for information to be written to or reading information from a subsequent RFID circuit element in a case where a discharged tag label has been stored within the storage space for some time has not been particularly considered. As a result, the radio signal may reach the RFID circuit element of the tag label stored within the storage space and cause malfunction.

When erroneous access such as that described above occurs when a subsequent RFID circuit element is to be accessed to create a tag label, the possibility exists that the subsequent RFID circuit element will no longer be favorably accessible. In this case, the product reliability of the RFID label, RFID card, etc., that uses this RFID circuit element decreases. Further, in a case where the completed RFID circuit element of the tag medium in the storage space is not write locked, the possibility also exists that erroneous writing may occur thereto, resulting in a decrease in information maintainability.

### SUMMARY OF THE INVENTION

It is therefore an object of the present invention to provide an apparatus for communicating with a RFID tag capable of preventing erroneous access of a RFID circuit element in a storage space from an apparatus-antenna device, thereby ensuring favorable access to each subsequent RFID circuit element for label creation.

### BRIEF DESCRIPTION OF THE DRAWINGS

FIG. 1 is a system configuration diagram which shows a RFID tag manufacturing system which applies an apparatus for communicating with a RFID tag according to an embodiment of the present invention.

FIG. 2 is a perspective view which shows the overall general structure of the apparatus for communicating with a RFID tag.

FIG. 3 is a perspective view which shows the casing of the cartridge.

FIG. 4 is a top view from the IV direction in FIG. 2 of the cartridge holder part in a state where the cartridge and opening/closing lid are removed from the apparatus main body.

FIG. 5 is a perspective view from the V direction in FIG. 2 of the cartridge holder part in a state where the cartridge and opening/closing lid are removed from the apparatus main body.

FIG. 6 is a conceptual configuration diagram which shows a detailed configuration of the apparatus for communicating with a RFID tag.

FIG. 7 is an explanatory diagram for describing in detail the structure of the cartridge.

FIG. 8 is a functional block diagram which shows the detailed functions of a radio frequency circuit.

FIG. 9 is a functional block diagram which shows the functional configuration of a RFID circuit element.

FIG. 10A is a top view of an example of the outer appearance of a RFID label, and FIG. 10B is a bottom view of an example of the outer appearance of a RFID label.

FIG. 11 is a lateral cross-sectional view taken along line XI-XI′ in FIG. 10.

FIG. 12 is a diagram which shows an example of a screen displayed on a terminal or a general purpose computer when RFID tag information is read or written.

FIG. 13 is a flowchart which shows a control procedure executed by the control circuit shown in FIG. 6.

FIG. 14 is a flowchart which shows a detailed procedure of step S200 shown in FIG. 13.

FIG. 15 is an explanatory diagram which conceptually shows from the side the positional relationship of the antenna, the tape feeding path, and the storage space.

FIG. 16 is a flowchart which shows a RFID tag information reading procedure executed by a control circuit.

FIG. 17 is a perspective view which shows the overall general structure of the apparatus for communicating with a RFID tag according to a modification in which the storage space is designed with a tilted structure.

FIG. 18 is a perspective view which shows the overall general structure of the apparatus for communicating with a RFID tag according to a modification in which the storage space is designed with a pull-out structure.

FIG. 19 is a perspective view which shows the overall general structure of the apparatus for communicating of a RFID tag according to a modification in which the storage space is designed with a rotating flip-up structure.

FIG. 20 is a perspective view which shows the overall general structure of the apparatus for communicating with a RFID tag according to a modification in which the storage space is designed with a rotating push-down structure.

FIG. 21 is a side view which shows relevant components of the apparatus for communicating with a RFID tag according to a modification in which the storage space itself is designed with a folding structure.

FIG. 22 is a perspective view which shows the overall general structure of the apparatus for communicating with a RFID tag according to a modification in which the storage space is designed with a vertical storage structure (drop-down structure).

FIG. 23 is an explanatory diagram which conceptually shows from the side the positional relationship of the antenna, the tape feeding path, and the storage space storage space.

FIG. 24 is a perspective view which shows the overall general structure of the apparatus for communicating with a RFID tag according to a modification in which the storage space is designed with a post-installable structure.

### DETAILED DESCRIPTION OF THE PREFERRED EMBODIMENTS

The following describes an embodiment of the present invention with reference to accompanying drawings.

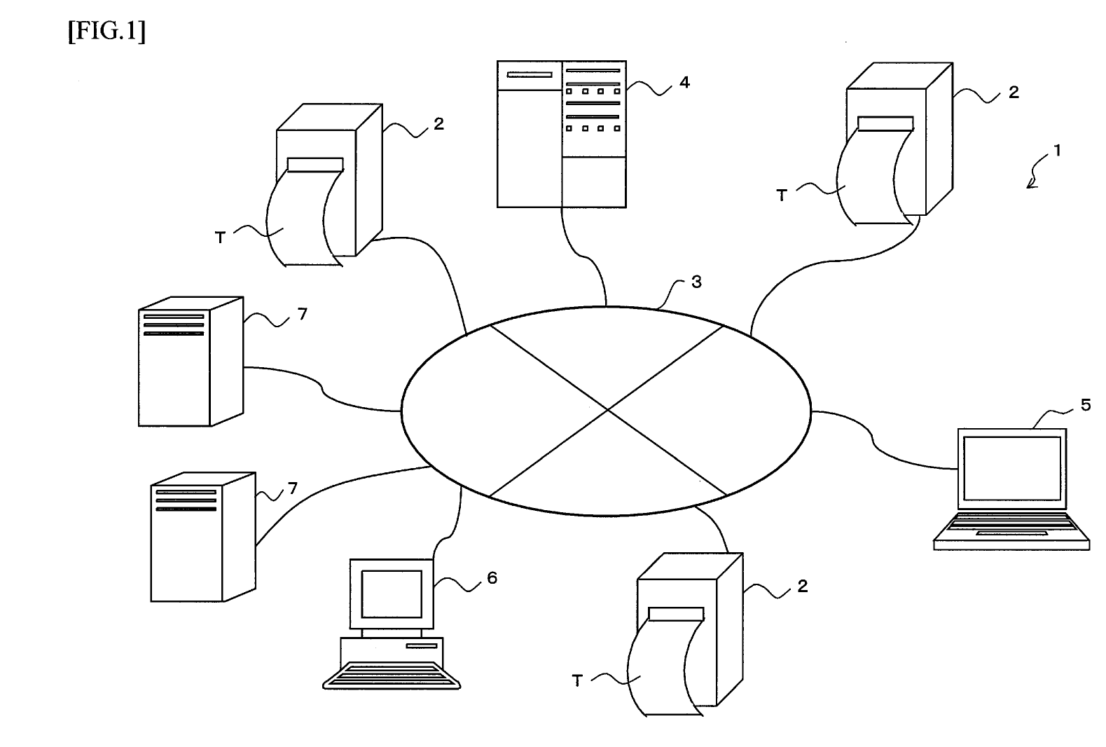

FIG. 1 is a system configuration diagram which shows a RFID tag manufacturing system which applies an apparatus for communicating with a RFID tag according to the present embodiment.

In the RFID tag manufacturing system 1 shown in FIG. 1, an apparatus 2 for communicating with a RFID tag according to the present embodiment is connected to a route server 4, a terminal 5, a general purpose computer 6, and a plurality of information servers 7 via a communication line 3 in a wired or wireless manner.

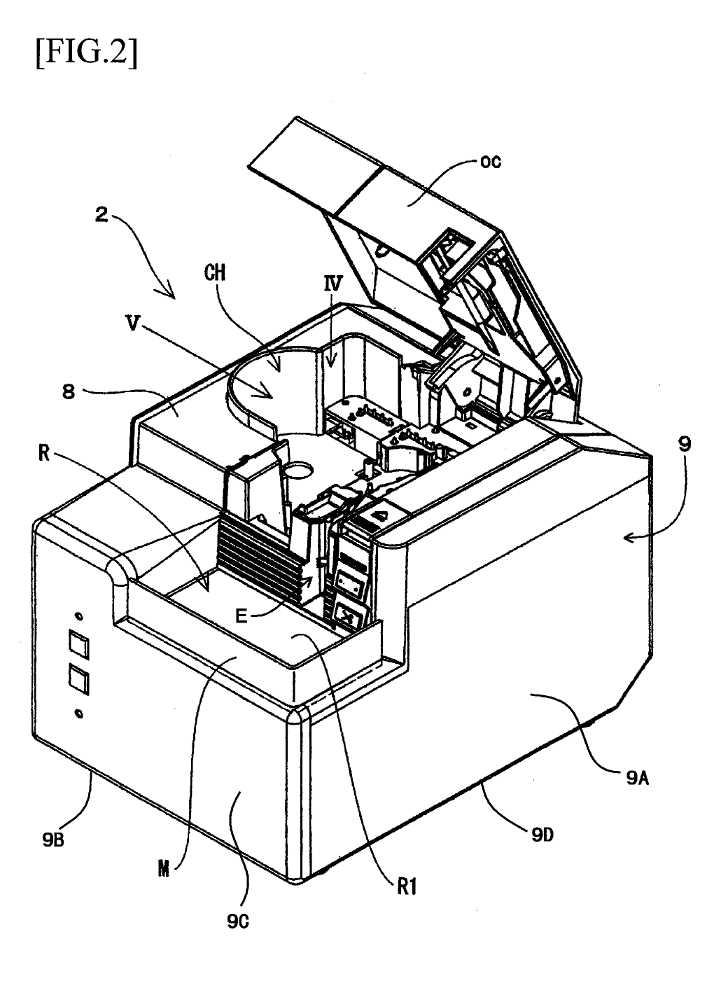

FIG. 2 is a perspective view which shows the overall general structure of the apparatus 2 for communicating with a RFID tag of the present embodiment (with a cartridge 100 to be described later removed, and an opening/closing lid OC opened).

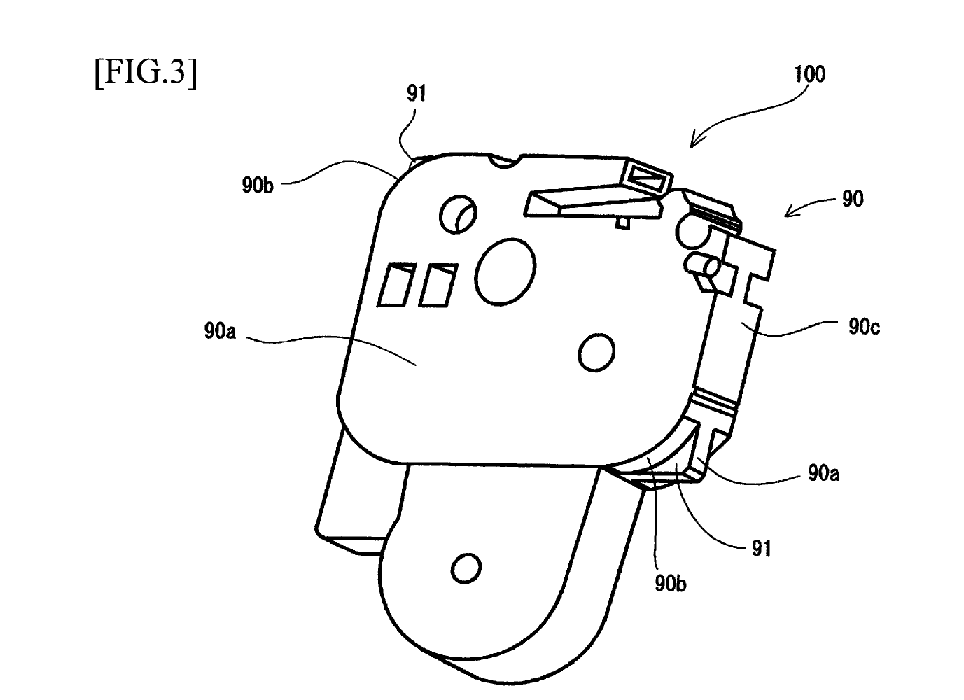

In FIG. 2, the apparatus 2 for communicating with a RFID tag comprises an apparatus main body 8, a cartridge holder part CH for holding a cartridge 100 (not shown, refer to FIG. 3 described later) detachably installed to the apparatus main body 8, an opening/closing lid OC rotatably connected to the apparatus main body 8 so that it covers the cartridge holder part CH when closed, and a storage space R that stores a tag medium (a tag label tape 110 with print described in detail later) discharged from a carry-out exit E.

The storage space R, in this example, comprises a horizontal collection surface R1 (storage space main body) provided as one part of a housing 9 of the apparatus main body 8 on the front face side (left lower side in FIG. 2) of the carry-out exit E. Further, a partition plate M is installed on the outer peripheral border part of the collection surface R1. The heightwise position of the collection surface R1 of the storage space R is disposed below the carry-out exit E in this example.

FIG. 3 is a perspective view which shows only the casing of the cartridge. FIG. 3 shows only a casing 90 constituting the housing of the cartridge 100, and not the base tape, ink ribbon, or print-receiving tape (to be described later) that is fed from the interior.

In FIG. 3, the casing 90 of the cartridge is generally formed into a substantially flat plate shape, providing a substantially semicircular protruding part (shown at the bottom in the figure) to a substantially rectangular solid, with the depth direction in the figure serving as the thickness direction. A large round part 90b is formed on the two corner parts (upper left and lower right corner parts in the figure) located on a diagonal line of the substantially rectangular solid when viewed from the flat plate surface side, and a locating rib 91 having a smaller thickness than that of a casing main body 90a is formed at the mid-position of the thickness direction of each round part 90b so as to protrude laterally.

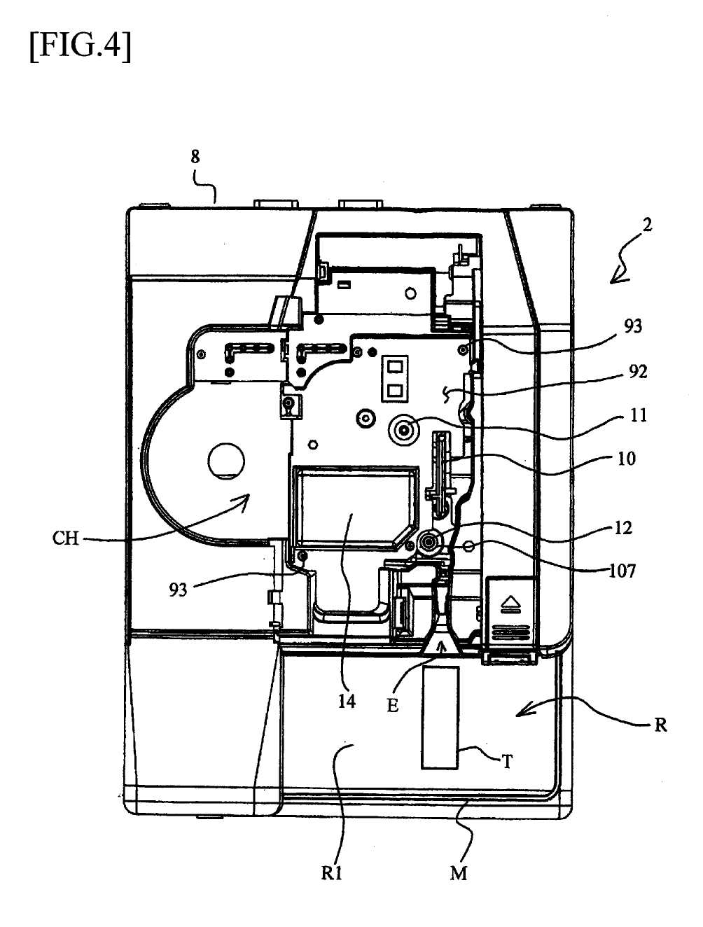

FIG. 4 is a top view from the IV direction in FIG. 2 of the cartridge holder part CH, with the cartridge 100 and the opening/closing lid OC removed from the apparatus main body 8.

In FIG. 4, the cartridge holder part CH is provided in the shape of a recess that permits the cartridge 100 to be detachably fit to the apparatus main body 8. A print head 10 to be described later, a ribbon take-up roller driving shaft 11, a feeding roller driving shaft 12, a tape feeding roller 107 driven by the feeding roller driving shaft 12, an antenna 14 (to be described in detail later) having directivity, etc., are provided on a holder bottom surface 92 positioned at the bottom of the cartridge holder part CH. Further, locating pins 93, each of identical height, protrude at the two corners corresponding to the positions of the two locating ribs 91 when the cartridge 100 is mounted.

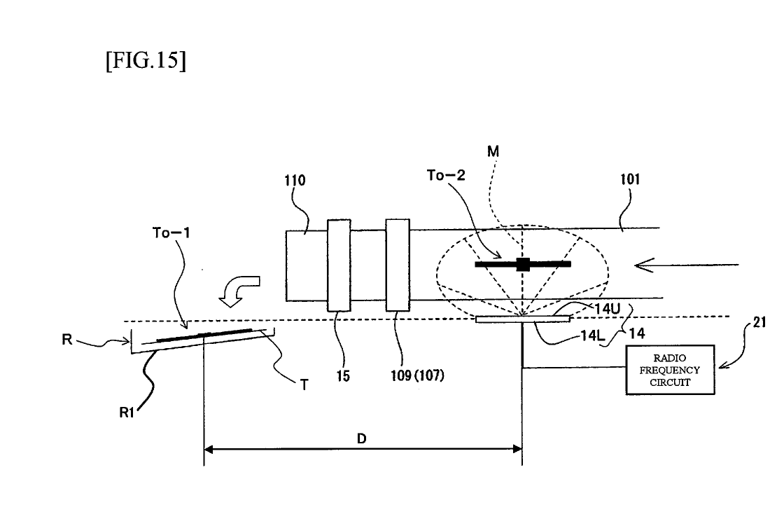

The storage space R is positioned in a direction from the antenna 14 that is not in line with the main lobe direction thereof (refer to FIG. 15 described later), and stores a RFID label T (described later in detail) discharged from the carry-out exit E by the tape feeding roller 107 after RFID communication is performed by the antenna 14.

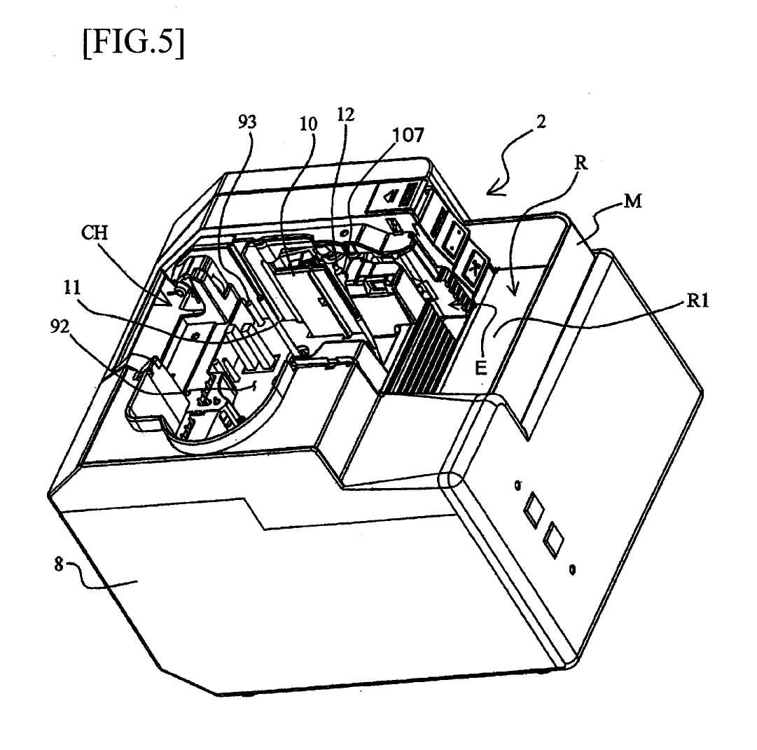

FIG. 5 is a perspective view from the V direction in FIG. 2 of the cartridge holder part CH with the cartridge 100 and the opening/closing lid OC removed from the apparatus main body 8.

In FIG. 5, the locating pin 93 (only one shown in FIG. 5) is installed orthogonal to the holder bottom surface 92 so that the tips of these locating pins 93 contact the respective locating ribs 91 so as to support the cartridge 100 when the cartridge 100 is installed to the cartridge holder part CH.

At this time, the antenna 14 (refer to FIG. 4) is provided so that, in this example, the upper surface is at substantially the same heightwise position as the holder bottom surface 92, and the carry-out exit E is at substantially the same heightwise position as (or somewhat below) the holder bottom surface 92. As a result, the heightwise position of the collection surface R1 of the storage space R positioned below the carry-out exit E as described above is below the heightwise position of the antenna 14.

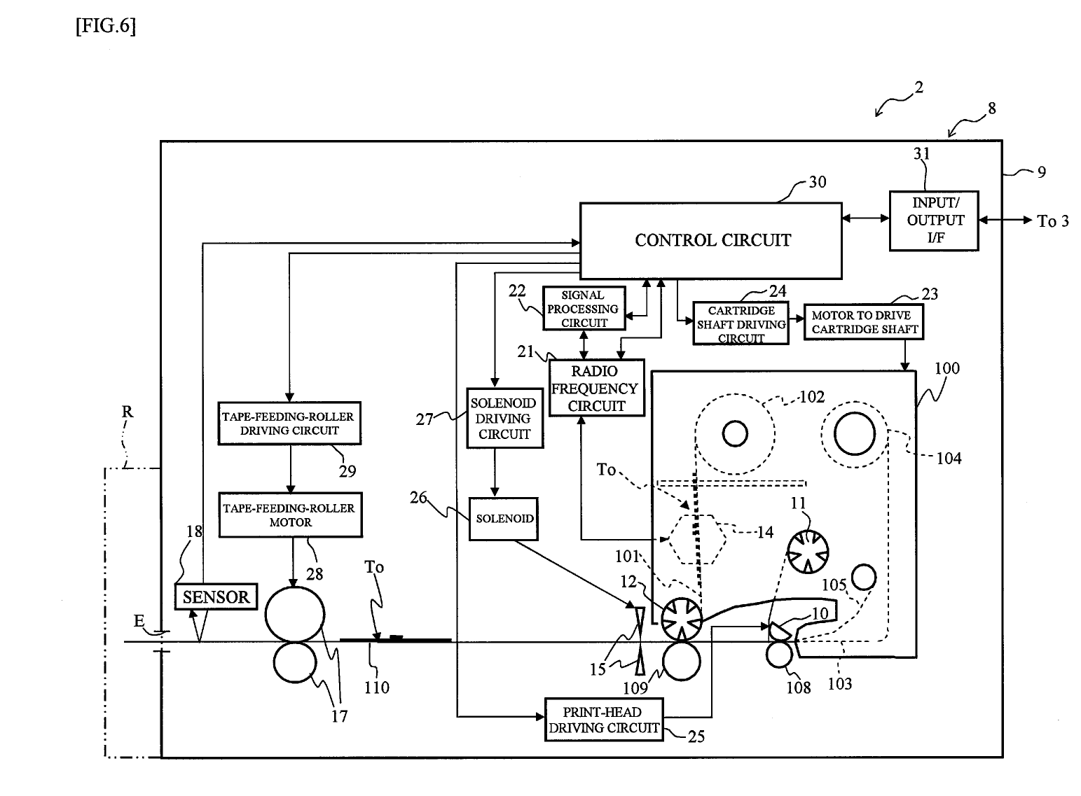

FIG. 6 is a conceptual configuration diagram which shows a detailed configuration of the apparatus 2 for communicating with a RFID tag.

In FIG. 6, the apparatus main body 8 of the apparatus 2 for communicating with a RFID tag comprises a print head (printing device, thermal head) 10 configured to print predetermined print (printing) on a print-receiving tape 103 fed out from a second roll (print-receiving tape roll) 104, a ribbon take-up roller driving shaft 11 configured to drive an ink ribbon 105 after the printing of the print-receiving tape 103, the feeding roller driving shaft 12 configured to adhere the print-receiving tape 103 to a base tape (tag medium, tag tape) 101 fed out from a first roll (roll of tape with RFID tag) 102, and to feed out the adhered tape from the cartridge 100 as a tag label tape 110 with print, the antenna 14 configured to transmit/receive signals to/from a RFID circuit element To (described in detail later) included in the tag label tape 110 with print via radio communication using a radio frequency band such as a UHF band or the like, a cutter 15 configured to cut the tag label tape 110 with print at a predetermined timing and to a predetermined length, thereby forming label-shaped RFID labels T (described in detail later), and a feeding roller 17 configured to transport the RFID labels T to a carry-out exit (output opening) E.

The antenna 14 comprises a directional antenna (in this example, a planar antenna, more specifically, a so-called patch antenna) having single-direction directivity (in this example, in the direction of the viewer in FIG. 6). Specifically, the antenna is a micro-strip antenna comprising a micro-strip antenna element on the inner side of the apparatus and a bottom board on the front face side (a slot antenna may also be used). Also, the antenna 14 is embedded so that an upper surface 14U (the bottom board, for example) of the holder bottom surface 92 appears as described above, near the feeding path of the surface that intersects (in this example, the surface that is orthogonal to) the tape surface of the feeding path of the base tape 101 fed out from the first roll 102 (from the feeding position from the roll to the feeding roller driving shaft 12). Furthermore, while a grounding potential surface (grounding surface) 14L (not shown) is positioned opposite the side where the antenna 14 appears, the collection surface R1 of the storage space R is positioned below this grounding potential surface 14L (refer to FIG. 15 described later).

A main lobe direction M (refer to FIG. 15 described later) of the antenna 14 having directivity is above (on the side of the viewer in FIG. 6) the upper surface 14U from where the antenna 14 appears, and the feeding path of the base tape 101 is positioned in this main lobe direction M as shown in the figure. In this example, the feeding direction of the feeding path of the base tape 101, the print-receiving tape 103, and the tag label tape 110 with print that adheres these is generally in the horizontal direction (the direction of the viewer in the figure), and feeding is performed so that the width direction of these tapes 101, 103, and 110 is in the vertical direction (direction orthogonal to the paper surface in the figure). The storage space R is positioned from the antenna 14 in a direction other than the main lobe direction M thereof (a direction that is not in line with the main lobe direction M; specifically, a null direction in this example; refer to FIG. 15).

Also, the apparatus main body 8 further comprises a radio frequency circuit 21 configured to access (read from or write to) the RFID circuit element To via the antenna 14, a signal processing circuit 22 configured to process signals read out from the RFID circuit element To, a motor 23 to drive cartridge shaft configured to drive the ribbon take-up roller driving shaft 11 and the feeding roller driving shaft 12, a cartridge shaft driving circuit 24 configured to control the driving of the motor 23 to drive cartridge shaft, a print-head driving circuit 25 configured to control the supply of power to the print head 10, a solenoid 26 configured to drive the cutter 15 to perform the cutting operation, a solenoid driving circuit 27 configured to control the solenoid 26, a tape-feeding-roller motor 28 configured to drive the feeding roller 17, and a control circuit 30 configured to control the radio frequency circuit 21, the signal processing circuit 22, the cartridge shaft driving circuit 24, the print-head driving circuit 25, the solenoid driving circuit 27, the tape-feeding-roller driving circuit 29, and the like, thereby controlling the operation of the overall system of the apparatus 2 for communicating with a RFID tag.

The control circuit 30 is a so-called microcomputer. While a detailed description thereof will be omitted, the control circuit 30 comprises a CPU which is a central processing unit, ROM, RAM, and the like, and performs signal processing according to a program previously stored in the ROM using the temporary storage function provided by the RAM. Furthermore, the control circuit 30 is connected to the communication line via the input/output interface 31, for example. Such an arrangement allows the control circuit 30 to exchange information with the route server 4, the other terminal 5, the general purpose computer 6, the information server 7, etc., which are connected to this communication line.

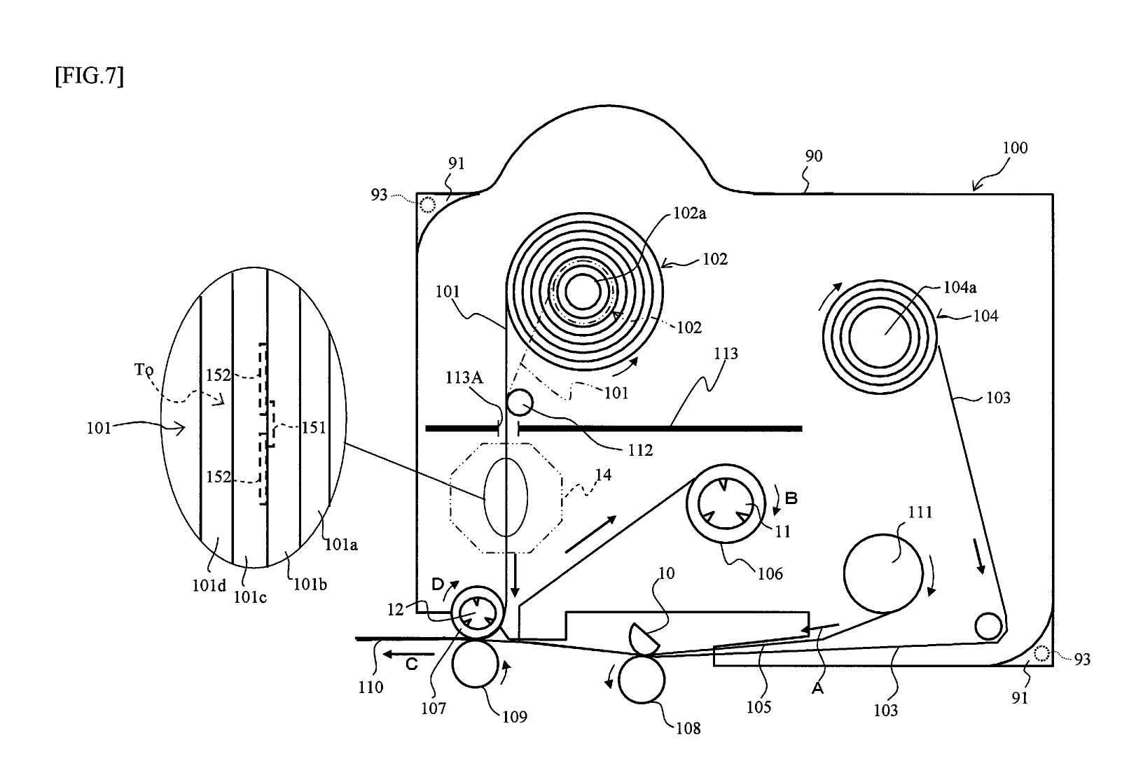

FIG. 7 is an explanatory diagram for describing the detailed configuration of the cartridge 100.

In FIG. 7, the cartridge 100 comprises the casing 90, the first roll 102, around which the strip base tape 101 is wound, and which is disposed within the casing 90, the second roll 104, around which the transparent print-receiving tape 103 is wound, with approximately the same width as that of the base tape 101, a ribbon supply roll 111 configured to supply the ink ribbon 105 (heat transfer ribbon, which is not required in a case of employing a thermo-sensitive tape as the print-receiving tape), a ribbon take-up roller 106 configured to rewind the ribbon 105 after the printing, the tape feeding roller 107, a guide roller 112, and a shielding material 113 in which the base tape 101 is inserted through a through-hole 113, thereby reducing the leakage of the radio signal from the antenna 14 to the first roll 102.

The tape feeding roller 107 is configured to adhere the base tape 101 and the print-receiving tape 103 to each other by applying pressure and transport the tag label tape 110 with print thus formed in the direction of the arrow A.

The first roll 102 stores, in a manner such that it is wound around a reel member 102a, the base tape 101, which has a structure in which a plurality of RFID circuit elements To are serially formed at a predetermined interval along the longitudinal direction.

In this example, the base tape 101 has a four-layer structure (refer to the partially enlarged view in FIG. 7) comprising an adhesive layer 101a formed of a suitable adhesive material, a colored base film 101b formed of PET (polyethylene terephthalate) or the like, an adhesive layer 101c formed of a suitable adhesive material, and a separation sheet 101d. The four layers of the base tape 101 are layered in that order from the side rolled to the inside (the right side in FIG. 7) to the side corresponding to the opposite side (the left side in FIG. 7).

An antenna (tag antenna) 152 configured to transmit/receive information is provided on the back side of the base film 101b (on the left side in FIG. 7) in an integrated manner in this example, and an IC circuit part 151 configured to store information is formed so that it is connected to the tag antenna 152, thereby constructing a RFID circuit element To.

The adhesive layer 101a configured to adhere to the print-receiving tape 103 at a later time is formed on the front face of the base film 101b (on the right side in FIG. 7). Furthermore, the separation sheet 101d is adhered to the back face (on the left side of FIG. 7) of the base film 101b by the adhesive layer 101c provided so as to include the RFID circuit element To. Note that the separation sheet 101d is peeled off when the RFID label T is adhered as a finished label-shaped product to a predetermined article or the like, thereby adhering the RFID label T to the article or the like by the adhesive layer 101c.

The second roll 104 has the print-receiving tape 103 wound around a reel member 104a. The print-receiving tape 103 is fed out from the second roll 104. The ribbon 105 is supplied on the back face side of the print-receiving tape 103 (i.e., on the side which is to be adhered to the base tape 101), and is driven by the ribbon supply roll 111 and the ribbon take-up roller 106. The ribbon 105 thus supplied is pressed by the print head 10, thereby coming into contact with the back face of the print-receiving tape 103.

The ribbon take-up roller 106 and the tape feeding roller 107 are respectively rotationally driven by a driving force of the motor 23 to drive cartridge shaft (refer to FIG. 6 described above) which is transmitted to the ribbon take-up roller driving shaft 11 and the feeding roller driving shaft 12. The motor 23 to drive cartridge shaft may be, for example, a pulse motor externally provided to the cartridge 100.

In the cartridge 100 configured as described above, the base tape 101 fed out from the first roll 102 is supplied to the tape feeding roller 107. On the other hand, the ink ribbon 105 driven by the ribbon take-up roller 106 and the ribbon supply roll 111 disposed on the back face side (i.e., the side which is to be adhered to the base tape 101) of the print-receiving tape 103 fed out from the second roll 104 are pressed by the print head 10, thereby being brought into contact with the back face of the print-receiving tape 103.

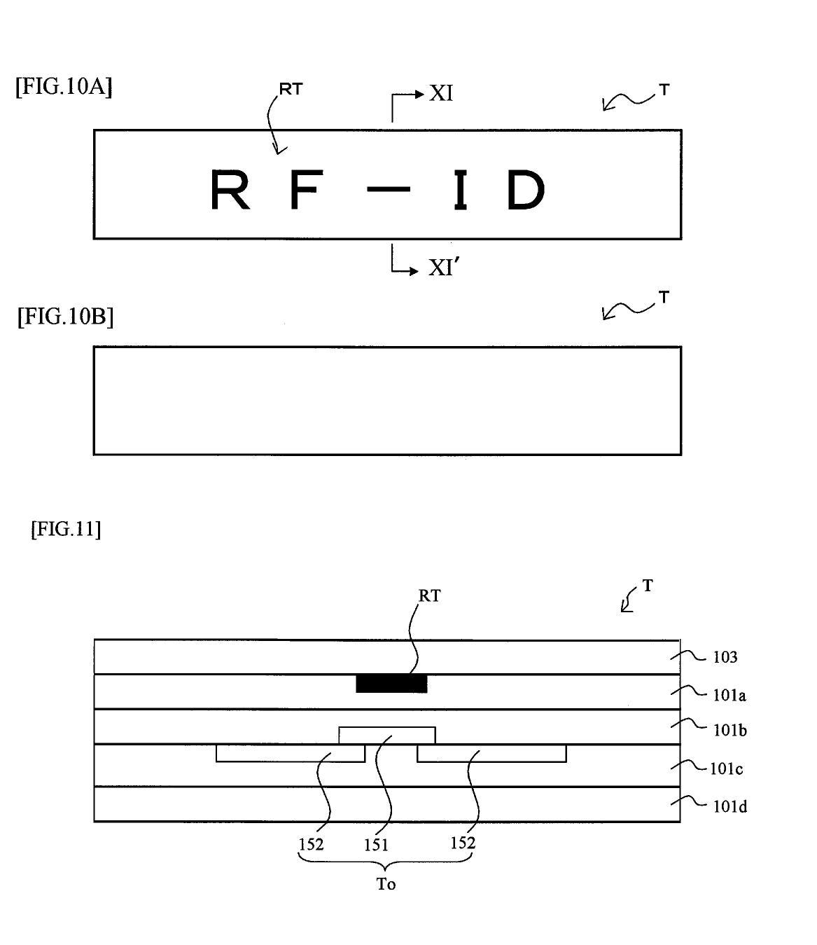

With such an arrangement, upon shifting the roll holder (not shown) from the separate position to the contact position after mounting the cartridge 100 to the cartridge holder part CH of the apparatus main body 8, the print-receiving tape 103 and the ink ribbon 105 are sandwiched between the print head 10 and a platen roller 108, and the base tape 101 and the print-receiving tape 103 are sandwiched between the tape feeding roller 107 and a sub-roller 109. Subsequently, the ribbon take-up roller 106 and the tape feeding roller 107 are synchronously rotationally driven along the directions denoted by the arrow B and the arrow D, respectively, by the driving force provided from the motor 23 to drive cartridge shaft. Furthermore, the feeding roller driving shaft 12, the sub-roller 109, and the platen roller 108 are connected to one another by a gear (not shown). With such an arrangement, upon driving the feeding roller driving shaft 12, the tape feeding roller 107, the sub-roller 109, and the platen roller 108 rotate, thereby feeding out the base tape 101 from the first roll 102 to the tape feeding roller 107 as described above. On the other hand, the print-receiving tape 103 is fed out from the second roll 104, and power is supplied to a plurality of heating elements of the print head 10 from the print-head driving circuit 25. As a result, printing is performed, thereby forming the printed characters RT (refer to FIG. 10 described later), which corresponds to the RFID circuit element To on the base tape 101 configured to be adhered, on the back face of the print-receiving tape 103. Then, the base tape 101 and the printed print-receiving tape 103 are adhered to each other by the tape feeding roller 107 and sub-roller 109 so as to form a single tape, thereby forming the tag label tape 110 with print, which is then transported to outside the cartridge 100. Furthermore, the ink ribbon 105, after the printing of the print-receiving tape 103, is rewound onto the ribbon take-up roller 106 by the driving force provided from the ribbon take-up roller driving shaft 11.

A guide roller 112 guides the feeding path of the base tape 101 fed out from the first roll 102 so that the path passes through a predetermined position (in this example, virtually the center position) in the planar direction of the antenna 14 (or is regulated within a predetermined range from that position), regardless of the change in the feeding position of the base tape 101 from the first roll 102 associated with the consumption of the base tape 101 (refer to the dashed two-dotted line in FIG. 7).

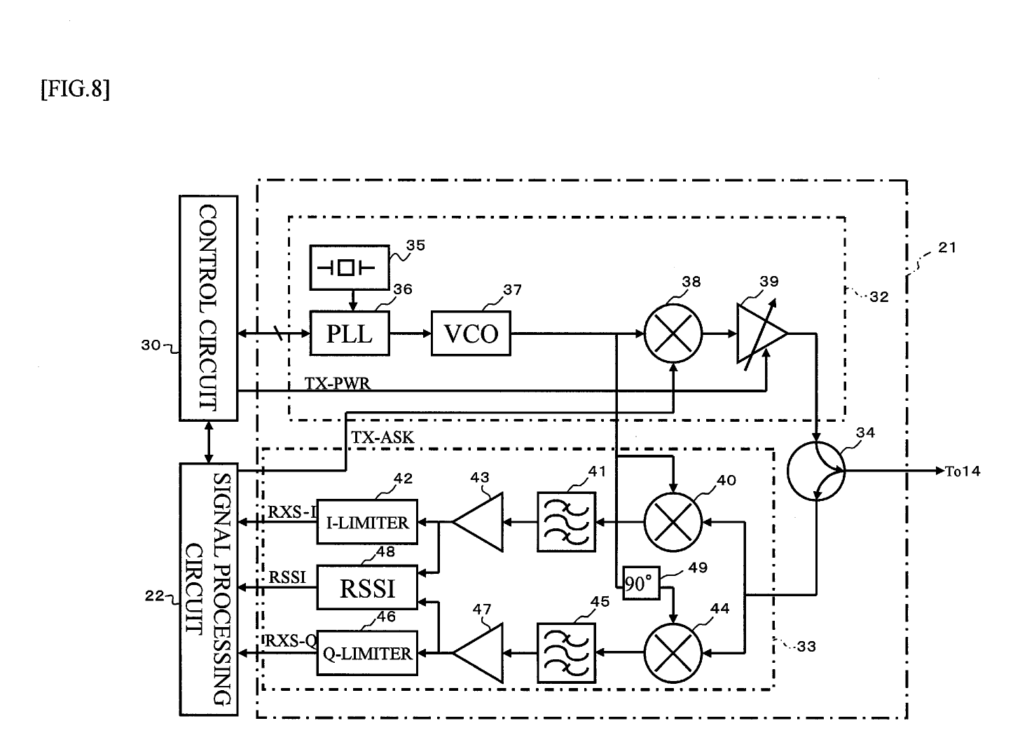

FIG. 8 is a functional block diagram which shows the detailed functions of the radio frequency circuit 21. In FIG. 8, the radio frequency circuit 21 comprises a transmitting portion 32 configured to transmit signals to the RFID circuit element To via the antenna 14, a receiving portion 33 configured to receive the reflected waves from the RFID circuit element To, received via the antenna 14, and a transmit-receive splitter 34.

The transmitting portion 32 comprises a crystal oscillator 35 configured to generate carrier waves for accessing (reading or writing) the RFID tag information of the IC circuit part 151 of the RFID circuit element To, a PPL (Phase Locked Loop) 36, a VCO (Voltage Controlled Oscillator) 37, a transmission multiplying circuit 38 (which may be replaced by a variable amplitude factor amplifier or the like in a case of amplitude modulation) configured to modulate (in this example, amplitude modulation according to the “TX_ASK” signal supplied from the signal processing circuit 22) the carrier waves generated based on a signal supplied from the signal processing circuit 22, and a variable transmission amplifier 39 configured to amplify the modulated waves modulated by the transmission multiplying circuit 38 with an application factor determined according to a “TX_PWR” signal supplied from the control circuit 30. With such an arrangement, the UHF frequency band is preferably employed for the carrier waves generated as described above, and the output signal from the transmission amplifier 39 is transmitted to the antenna 14 via the transmit-receive splitter 34, whereby the output signal is supplied to the IC circuit part 151 of the RFID circuit element To.

The receiving portion 33 comprises a I-receiving-signal multiplying circuit 40 configured to multiply the reflected waves received from the RFID circuit element To via the antenna 14 by the carrier waves generated as described above, a I-band-pass filter 41 configured to extract only the signals within the necessary frequency band range from the output signals of the I-receiving-signal multiplying circuit 40, a I-receiving signal amplifier 43 configured to amplify the output signal from the I-band-pass filter 41 and supply the output signal thus amplified to a I-limiter 42, a Q-receiving-signal multiplying circuit 44 configured to multiply the reflected waves received from the RFID circuit element To via the antenna 14 by the carrier waves that have been delayed by a phase angle of 90° by a phase shifter 49 after having been generated as described above, a Q-band-pass filter 45 configured to extract only the signals within the necessary frequency band range from the output signals of the Q-receiving-signal multiplying circuit 44, and a Q-receiving signal amplifier 47 configured to amplify the output signal of the Q-band-pass filter 45 and supply the signal thus amplified to a Q-limiter 46. With such an arrangement, the signal “RXS-I” outputted from the I-limiter 42 and the signal “RXS-Q” outputted from the Q-limiter 46 are inputted to the signal processing circuit 22 for further processing.

Furthermore, the output signals of the I-receiving signal amplifier 43 and the Q-receiving signal amplifier 47 are inputted to an RSSI (Received Signal Strength Indicator) circuit 48. The signal “RSSI” which indicates the strength of these signals is inputted to the signal processing circuit 22. In this way, the apparatus 2 for communicating with a RFID tag of the present embodiment demodulates the reflected waves from the RFID circuit element To by I-Q quadrature demodulation.

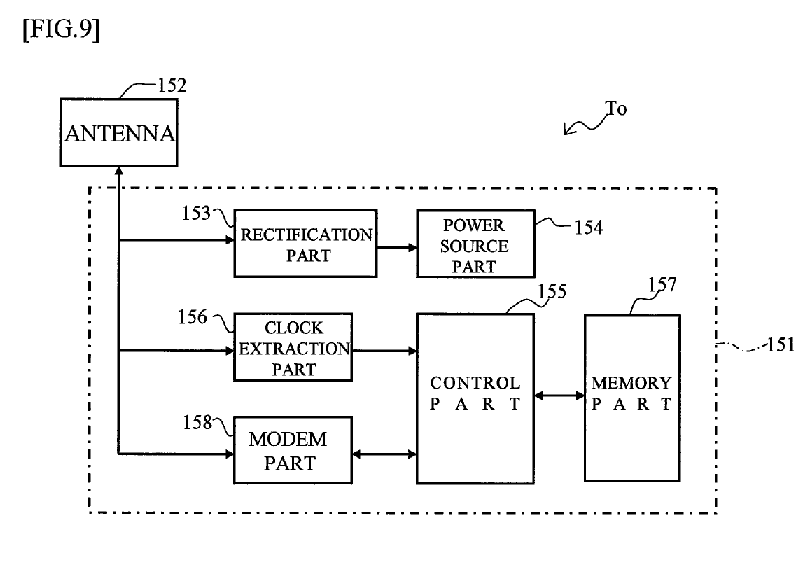

FIG. 9 is a functional block diagram which shows the functional configuration of the RFID circuit element To. In FIG. 7, the RFID circuit element To comprises the antenna 152 configured to transmit/receive signals in a non-contact manner to/from the antenna 14 consisting of a dipole antenna of the apparatus 2 for communicating with a RFID tag using radio waves of the UHF band or the like, and the IC circuit part 151 connected to the antenna 152.

The IC circuit part 151 comprises a rectification part 153 configured to rectify the carrier waves received via the antenna 152, a power source part 154 configured to store the energy of the carrier waves thus rectified by the rectification part 153, which serves as a driving power supply, a clock extraction part 156 configured to extract the clock signals from the carrier waves thus received by the antenna 152 and supply the clock signals thus extracted to a control part 155, a memory part 157 configured to store predetermined information signals, a modem part 158 connected to the antenna 152, and the control part 155 configured to control the operation of the RFID circuit element To via the rectification part 153, the clock extraction part 156, the modem part 158, etc.

The modem part 158 demodulates the communication signals which have been transmitted from the antenna 14 of the apparatus 2 for communicating with a RFID tag, and which have been received via the antenna 152, and modulates and reflects the carrier waves received via the antenna 152 based on a response signal from the control part 155.

The control part 155 analyzes the received signals demodulated by the modem part 158, generates the response signals based on the information signals stored in the memory part 157, and executes basic control such as the control for issuing a response from the modem part 158.

The clock extraction part 154 extracts the clock component from the received signal and extracts the clock to the control part 157, supplying the clock corresponding to the speed of the clock component of the received signal to the control part 157.

FIGS. 10A and 10B are diagrams which show an example of the outer appearance of a RFID label T cut from the tag label tape 110 with print after RFID circuit element To information writing as described above. FIG. 10A is a top view, and FIG. 10B is a bottom view. FIG. 11 is a lateral cross-sectional view taken along line XI-XI′ in FIG. 10.

As shown in FIGS. 10A, 10B, and 11, the RFID label T has a five-layer structure in which the print-receiving tape 103 is added to the four-layer structure shown in FIG. 7. The five-layer structure comprises the print-receiving tape 103, the adhesive layer 101a, the base film 101b, the adhesive layer 101c, and the separation sheet 101d, in that order, from the side of the print-receiving tape 103 (upper side in FIG. 11) to the side corresponding to the opposite side (lower side in FIG. 11). Furthermore, the RFID circuit element To, including the antenna 152 provided on the back side of the base film 101b as described above, is provided within the adhesive layer 101c, and the printed characters RT (in the example, the text “RF-ID” which indicates the type of RFID label T) are printed on the back face of the print-receiving tape 103.

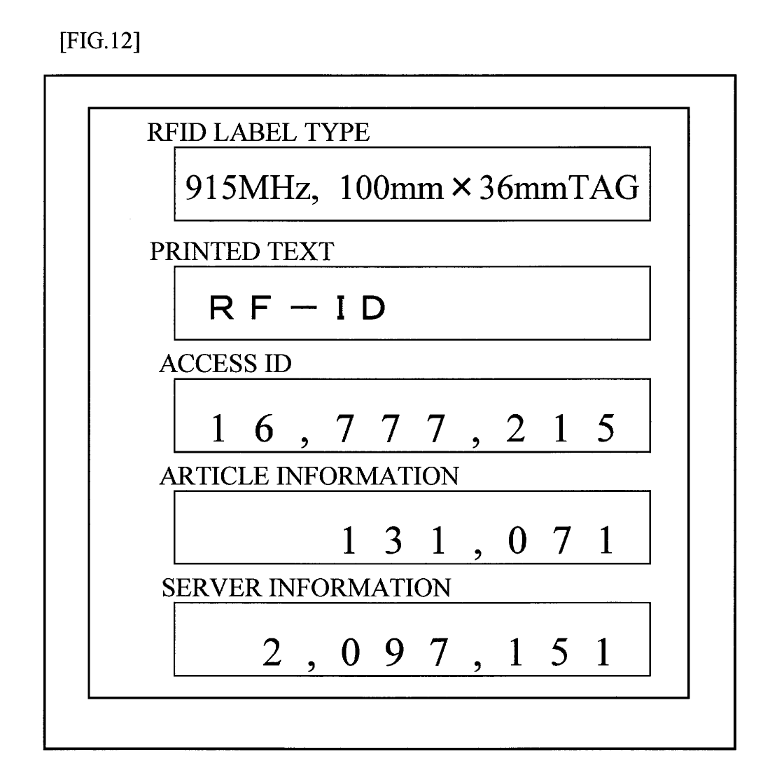

FIG. 12 is a diagram which shows an example of a screen displayed on the terminal 5 or the general purpose computer 6 when the apparatus 2 for communicating with a RFID tag accesses (reads or writes) RFID tag information in the IC circuit part 151 of the RFID circuit element To.

In FIG. 12, the type of RFID label T (the access frequency and tape dimensions), the printed characters RT printed correspondingly to the RFID circuit element To, an access (writing/reading) ID which is the unique ID of the RFID circuit element To, an article information address stored in the information server 7, a storage destination address of the corresponding information stored in the router server 4, etc., can be displayed on the terminal 5 or the general purpose computer 6. With such an arrangement, upon operating the terminal 5 or the general purpose computer 6, the apparatus 2 for communicating with a RFID tag operates. Specifically, the printed characters RT are printed on the print-receiving tape 103. Furthermore, information such as the writing ID and the article information is written to the IC circuit part 151 (or, the RFID tag information such as the reading ID and article information stored beforehand in the IC circuit part 151 is read out). Furthermore, “reading/writing” of the RFID tag information in this case includes the transmission of signals that halt a response such as a signal based on a “Kill” or “Sleep” command, in addition to what has been widely referred to as the reading/writing of data.

At the time of the above-described writing (or readout), the correspondence between the ID of the RFID label T thus produced and the information written to (or read from) the IC circuit part 151 of the RFID label T is stored in the route server 4, and can be referred to as required.

Next, the control procedure executed by the control circuit 30 will be described.

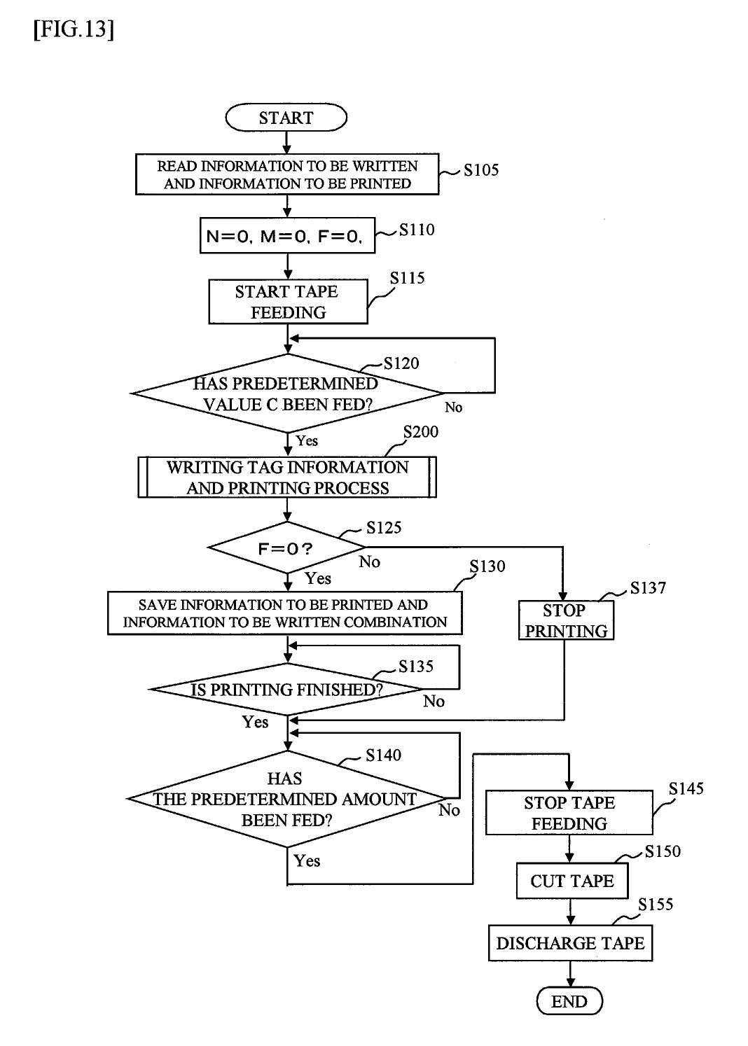

FIG. 13 is a flowchart which shows a control procedure executed by the control circuit 30 when the above-described RFID label T is produced, that is, when predetermined print is printed on the print-receiving tape 103 by the print head 10 while the print-receiving tape 103 is fed, RFID tag information is written to the base tape 101 while the base tape 101 is fed, the print-receiving tape 103 and the base tape 101 are adhered to each other to form the tag label tape 110 with print, and the tag label tape 110 with print is subsequently cut in increments of the RFID circuit element To so as to form the RFID labels T.

In FIG. 13, first, in step S105, upon performance of the writing operation by the apparatus 2 for communicating with a RFID tag, the flow starts. Then, the RFID tag information, which is to be written to the RFID circuit element To and which is inputted by operating the terminal 5 or the general purpose computer 6, and the information to be printed for printing the RFID label T from the print head 10 in correspondence with the RFID tag information are read out via the communication line 3 and the input/output interface 31.

Subsequently, in step S110, a variable M for counting the number of times a retry is made (the number of access retries) when no response is returned from the RFID circuit element To, and a flag F that indicates communication success or failure are initialized to zero.

Then, in step S115, a control signal is outputted to the cartridge shaft driving circuit 24, whereupon the ribbon take-up roller 106 and tape feeding roller 107 are rotationally driven by the driving force of the motor 23 to drive cartridge shaft. With such an arrangement, the base tape 101 is fed out from the first roll 102 and supplied to the tape feeding roller 107, and the print-receiving tape 103 is fed out from the second roll 104. Furthermore, a control signal is outputted to the tape-feeding-roller motor 28 via the tape-feeding-roller driving circuit 29 so as to rotationally drive the feeding roller 17. As a result, the base tape 101 and the print-receiving tape 103 are adhered to each other by the tape feeding roller 107 (and the sub-roller 109), thereby forming a tape in the form of a single member as described above. With such an arrangement, the tape thus formed, which is the tag label tape 110 with print, is transported to outside the cartridge 100.

Subsequently, the flow proceeds to step S120 where a decision is made as to whether or not the base tape 101 and the print-receiving tape 103 have been sufficiently transported a predetermined value C (for example, a transport distance sufficient for the completion of RFID tag information writing and printing to the preceding RFID circuit element To and the print-receiving tape 103 print area and for the arrival of the next RFID circuit element To at a position virtually opposite the antenna 14). This transport distance decision may be made, for example, by detecting a suitable identification mark provided on the base tape 101 using a known tape sensor additionally provided for this purpose. In a case where the decision has been made that the condition has been satisfied, the flow proceeds to step S200.

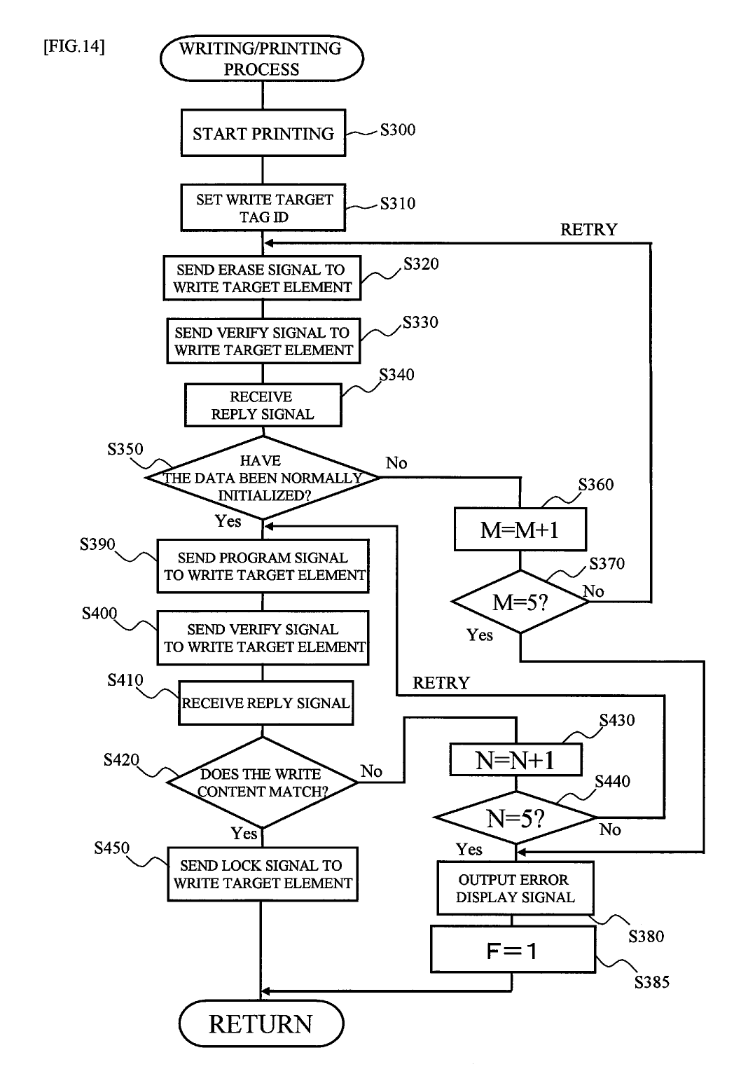

In step S200, the tag information writing and printing process is performed and the memory is initialized (erased) for writing. Subsequently, the transmission signal that includes the RFID tag information is transmitted and written to the RFID circuit element To in the base tape 101, and the printed characters RT are printed by the print head 10 in the area corresponding to the print-receiving tape 103 (for details, refer to FIG. 14 described later). After step S200 is completed, the flow proceeds to step S125.

In step S125, the decision is made as to whether or not the flag F equals zero. In a case where the writing process has been normally completed, the flag F remains zero (refer to step S385 in the flow shown in FIG. 14, described later). Accordingly, the decision is made that the condition has been satisfied, and the flow proceeds to step S130.

In step S130, the combination of the information written to the RFID circuit element To in step S200 as described above and the corresponding information to be printed already printed by the print head 10 is outputted via the input/output interface 31 and the communication line 3 via the terminal 5 or general purpose computer 6, and is stored in the information server 7 or the route server 4. The stored data are stored and maintained, for example, within a database referable from the terminal 5 or the general purpose computer 6 as required.

Subsequently, in step S135, confirmation is made as to whether or not printing has been completed for the entire region of the print-receiving tape 103 that corresponds to the RFID circuit element To which is the processing target at the current point in time. After the confirmation, the flow proceeds to step S140.

Furthermore, in step S125 described above, in a case where, due to any cause, the writing process has not been normally completed, the flag F is set to 1 (refer to step S385 in the flow shown in FIG. 14 described later). Accordingly, the decision is made that the condition has not been satisfied in step S125, and the flow proceeds to step S137 where a control signal is outputted to the print-head driving circuit 25 so as to stop the supply of power to the print head 10, whereupon the printing is stopped. By stopping the printing before completion in this way, the control circuit 30 clearly indicates that the RFID circuit element To is defective. Furthermore, rather than stopping the printing before completion, such a condition may also be indicated by an alarm or the printing of characters of a specific form that call attention to the defect.

After step S137 is completed, the flow proceeds to step S140.

In step S140, a decision is made as to whether or not the tag label tape 110 with print has been sufficiently further transported a predetermined amount. [For example, an arrangement may be made in which a decision is made as to whether or not the RFID circuit element To, which is the target, and the entire printed region of the print-receiving tape 103 that corresponds to the RFID circuit element To have sufficiently extended beyond the position of the cutter 15 to a predetermined length (margin).] This decision with regard to the transported distance may be made by detecting a suitable identification mark using a tape sensor, similar to the above-described step S120. In a case where the decision has been made that the condition has been satisfied, the flow proceeds to step S145.

In step S145, control signals are outputted to the cartridge shaft driving circuit 24 and the tape-feeding-roller driving circuit 29 so as to stop the driving of the motor 23 to drive cartridge shaft and the tape-feeding-roller motor 28. As a result, the rotations of the ribbon take-up roller 106, the tape feeding roller 107, and the feeding roller 17 are stopped. As a result, the feeding out of the base tape 101 from the first roll 102, the feeding out of the print-receiving tape 103 from the second roll 104, and the transport of the tag label tape 110 with print by the feeding roller 17 stop.

Subsequently, in step S150, a control signal is outputted to the solenoid driving circuit 27 so as to drive the solenoid 26. The solenoid 26 is driven such that the tag label tape 110 with print is cut off by the cutter 15. As described above, at this point in time, the entire tag label tape 110 with print to which the RFID circuit element To, which is the processing target, and the printed region of the print-receiving tape 103 that corresponds thereto have been adhered sufficiently extends beyond the cutter 15. Thus, a label-shaped RFID label T, which includes the RFID circuit element To which the RFID tag information has been written, and on which predetermined printing has been performed correspondingly thereto, is formed by cutting the tag tape 110 with print using the cutter 15.

Subsequently, the flow proceeds to step S155 where a control signal is outputted to the tape-feeding-roller driving circuit 29 so as to drive the tape-feeding-roller motor 28 again, thereby rotating the feeding roller 17. As a result, the feeding roller 17 begins transport again. Accordingly, the RFID label T thus formed in the shape of a label in the step S150 is transported toward the carry-out exit E, discharged to outside the apparatus 2 from the carry-out exit E, and sequentially stored in the storage space R (refer to FIG. 2, FIG. 4, FIG. 5, etc.).

FIG. 14 is a flowchart which shows the detailed procedure of the step S200.

In FIG. 14, first, in step S300, a control signal is outputted to the print-head driving circuit 25 so as to supply power to the print head 10. In this step, the power is supplied such that the printed characters RT such as letters, symbols, barcodes, or the like, read out in step S105 of the above-described FIG. 13 are printed in a region corresponding to the RFID circuit element To, which is the processing target, on the print-receiving tape 103 (i.e., the region which is to be adhered to the back face of the RFID circuit element To by the tape feeding roller 107).

Then, in step S310, the identification number ID to be assigned to the RFID circuit element To which writing is to be performed is set using a known suitable method.

Subsequently, in step S320, an “Erase” command for initializing the information stored in the memory part 157 of the RFID circuit element To is outputted to the signal processing circuit 22. Then, the signal processing circuit 22 generates an “Erase” signal as access information based upon the “Erase” command, and the “Erase” signal is transmitted to the RFID circuit element To which writing is to be performed via the radio frequency circuit 21, thereby initializing the memory part 157.

Next, in step S330, a “Verify” command for confirming the contents of the memory part 157 is outputted to the signal processing circuit 22. The signal processing circuit 22 generates a “Verify” signal as access information based upon the “Verify” command, and the “Verify” signal is transmitted to the RFID circuit element To which writing is to be performed via the radio frequency circuit 21, prompting a reply. Subsequently, in step S340, a reply signal transmitted from the RFID circuit element To in response to the “Verify” signal is received via the antenna 14, and incorporated via the radio frequency circuit 21 and the signal processing circuit 22.

Next, in step S350, the information stored in the memory part 157 of the RFID circuit element To is checked based upon the reply signal, and the decision is made as to whether or not the memory part 157 has been normally initialized.

In a case where the decision has been made that the condition has not been satisfied, the flow proceeds to step S360 where M is incremented by one. Then, in step S370, the decision is made as to whether or not M is equal to five. In a case where M is less than or equal to four, the decision is made that the condition has not been satisfied and the flow returns to step S320 and the same procedure is repeated. In a case where M equals five, the flow proceeds to step S380 where an error display signal is outputted to the terminal 5 or the general purpose computer 6 via the input/output interface 31 and the communication line 3 so as to display the corresponding writing failure (error) Subsequently, the flow ends. As described above, with such an arrangement, a maximum of five retries are performed even if initialization fails.

In a case where the decision is made that the condition is satisfied in step s350, the flow proceeds to step S390 where a “Program” command for writing desired data to the memory part 157 is outputted to the signal processing circuit 22. The signal processing circuit 22 generates a “Program” signal, which is access information including the ID information to be written, based upon the “Program” command. The “Program” signal thus created is transmitted to the target RFID circuit element To via the radio frequency circuit 21 so as to write the information to the memory part 157 in the RFID circuit element To.

Subsequently, in step S400, the “Verify” command is outputted to the signal processing circuit 22. The signal processing circuit 22 generates a “Verify” signal as access information based upon the “Verify” command, and the “Verify” signal is transmitted to the RFID circuit element To which writing is to be performed via the radio frequency circuit 21, prompting a reply. Then, in step S410, a reply signal transmitted from the RFID circuit element To, to which writing is to be performed in response to the “Verify” signal is received via the antenna 14, and incorporated via the radio frequency circuit 21 and the signal processing circuit 22.

Next, in step S420, the information stored within the memory part 157 of the RFID circuit element To is checked based upon the reply signal, and the decision is made as to whether or not the transmitted predetermined information has been normally stored in the memory part 157.

In a case where the decision is made that the condition has not been satisfied, the flow proceeds to step S430 where N is incremented by one. Then, in step S440, the decision is made as to whether or not N is equal to five. In a case where N is less than or equal to four, the decision is made that the condition has not been satisfied and the flow returns to step S390 where the same procedure is repeated. In a case where N is equal to five, the flow returns to step S380 where the corresponding writing failure (error) is similarly displayed on the terminal 5 or the general purpose computer 6. Subsequently, in step S385, the flag F is set to one and the flow ends. As described above, with such an arrangement, a maximum of five retries are performed even if information writing fails.

In a case where the decision is made that the condition is satisfied in step S420, the flow returns to step S450 and a “Lock” command is outputted to the signal processing circuit 22. The signal processing circuit 22 generates a “Lock” signal based upon the “Lock” command, and the “Lock” signal is transmitted to the RFID circuit element To which writing is to be performed via the radio frequency circuit 21, thereby prohibiting the writing of new information to the RFID circuit element To. As a result, the writing of the RFID tag information to the target RFID circuit element To is completed, the RFID circuit element To is discharged as described above, and the flow ends.

Thus, according to the above-described routine, corresponding RFID tag information is written to the target RFID circuit element To on the base tape 101, and the print characters RT corresponding to the RFID tag information in the corresponding region of the print-receiving tape 103 are printed.

In the above, the tape feeding roller 107, the sub-roller 109, and the feeding roller 17 constitute the feeding device described in each claim configured to feed the tag medium to the carry-out exit.

Thus, with the apparatus 2 for communicating with a RFID tag of the present embodiment configured as described above, when the RFID label T is created, the cartridge 100 which stores the base tape 101 containing the RFID circuit element To is installed to the cartridge holder part CH, and radio communication is performed from the apparatus antenna to the RFID circuit element To of the base tape 101 continually supplied from the cartridge 100. Further, printing is performed in the print region corresponding to the RFID circuit element To on the print-receiving tape 103 by the print head 10 so as to generate the tag label 110 with print, and the tag label 110 with print thus created is cut at a predetermined length by the cutter 15 so as to create the RFID label T. Then, the RFID label T thus created is sequentially discharged to outside the apparatus 2 for communicating with a RFID tag from the carry-out exit E, and sequentially stored in the storage space R.

With such an arrangement, in the present embodiment, the storage space R is provided in a direction other than the main lobe direction of the antenna 14 (a direction not in line with the main lobe direction; in this example, specifically a null direction), i.e., a position that substantially deviates from the communicable direction from the antenna 14. The effect thus achieved will now be described in detail with reference to FIG. 15.

FIG. 15 is an explanatory diagram which conceptually shows from the side the positional relationship of the antenna 14, feeding path of the tape 101, etc., and the storage space R. In FIG. 15, radio communication is performed between the RFID circuit element To-1 provided to the fed base tape 101 and the antenna 14 as described above so as to access (read information from and write information to) the IC circuit part 151 of the RFID circuit element To from the radio frequency circuit 21. The base tape 101 after the IC circuit part 151 is thus accessed is adhered to and integrated with the print-receiving tape 103 between the tape feeding roller 107 and sub-roller 109, fed in the direction denoted by the arrow in the figure, transported along the feeding path as the tag label tape 110 with print, cut by the cutter 15 so as to be formed into the RFID label T (configured to include the RFID circuit element To-1) of a predetermined length, and stored in the storage space R.

With such an arrangement, as shown in the figure, the antenna 14 comprising a planar antenna that spreads to the upper side of the apparatus 2 for communicating with a RFID tag, with the main lobe direction M toward the feeding path of the base tape 101. That is, a section of the feeding path is disposed in a position that laterally crosses the main lobe. Conversely, as described above, the storage space R is positioned below the antenna 14 and the feeding path of the tapes 101, 110, etc, and is thus positioned in a direction that is not in line with the main lobe direction M of the antenna 14. That is, the storage space R is positioned below the radio-wave emission plane (dotted line in the figure) of the planar antenna. As a result, even if the RFID label T discharged from the carry-out exit E is stored in the storage space R for a while, subsequent erroneous access of the RFID circuit element To-1 of the RFID label T from the antenna 14 is prevented. As a result, in a case where the following RFID circuit element To-2 is accessed so as to create a new RFID label T, the existence of the RFID circuit element To-1 of the RFID label T located in the storage space R does not affect communication, thereby permitting without fail favorable access of the RFID circuit element To-2. This improves the product reliability of the RFID label T comprising the RFID circuit element To-2 that is to be subsequently created. Further, even in a case where the completed RFID circuit element To-1 in the storage space R is not write locked, the present embodiment also has the additional effect of preventing erroneous writing thereto and improving information maintainability.

Further, the distance D from the antenna 14 to the RFID label T stored in the storage space R is smaller than the wavelength λ of the feeding wave of the radio wave used for communication and, as described above, the storage space R exists in a direction that is not in line with the main lobe direction M of the antenna 14 within the distance of a single wavelength, thereby preventing without fail erroneous access of the RFID circuit element To of the RFID label T in the storage space R and providing an apparatus for communicating with a RFID tag that is small in size.

Note that various modifications may be made according to the present embodiment without departing from the spirit and scope of the invention, in addition to the above-described embodiment. Description will be made below regarding such modifications. Note that, in each figure, the same parts are denoted by the same reference numerals, and descriptions thereof will be suitably omitted.

(1) In a Case where the RFID Circuit Element is Read-Only

While the above embodiment has been described in connection with an illustrative scenario in which the RFID tag information is transmitted to the RFID circuit element To and written to the IC circuit part, the present invention is not limited thereto. That is, the present invention can also be applied to a case where a label is created by reading RFID tag information from a read-only RFID circuit element To in which predetermined RFID tag information (tag ID information, etc.) is stored in advance in a non-erasable manner, and printing print corresponding to the RFID tag information thus read.

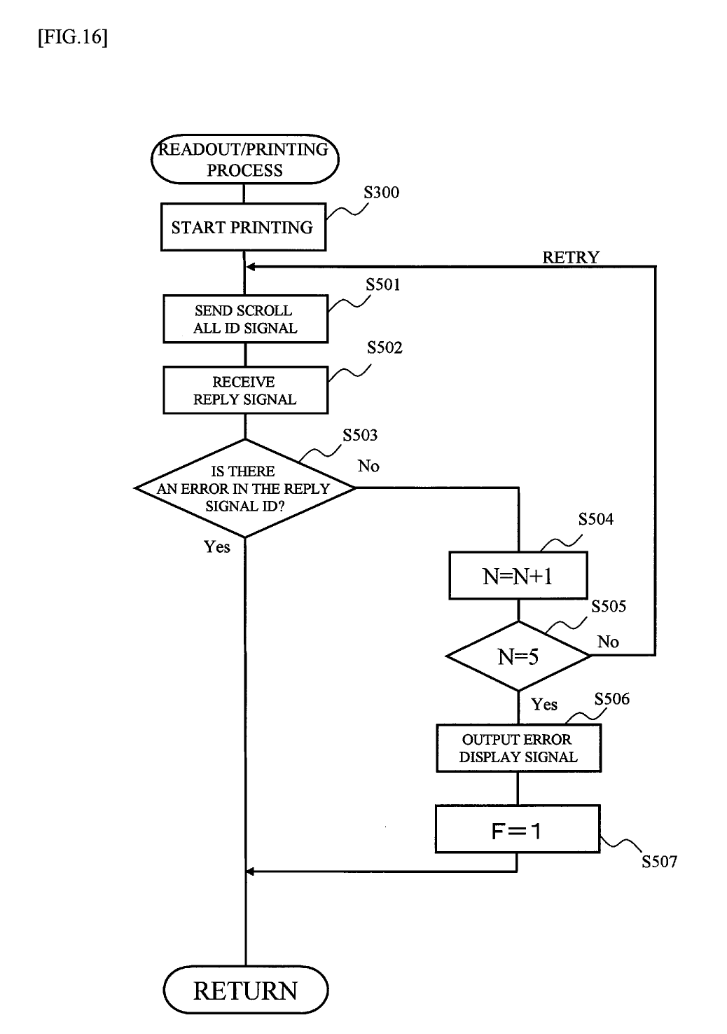

In this case, in step S105 in FIG. 13, only the information to be printed is read out and, in step S200, the RFID tag information reading process is performed (refer to FIG. 16, described later in detail). Next, in step S130, the combination of the information to be printed and the read RFID tag information is saved.

FIG. 16 is a flowchart which shows the detailed procedure of the RFID tag readout and printing process.

In FIG. 16, in step S300, similar to the flowchart shown in FIG. 14, a control signal is outputted to the print-head driving circuit 25 so as to supply power to the print head 10. In this step, the power is supplied such that the printing of the printed characters RT such as letters, symbols, barcodes, or the like, read out in step S105 of the above-described FIG. 13 is started in a region corresponding to the RFID circuit element To, which is the processing target, on the print-receiving tape 103 (i.e., the region which is to be adhered to the back face of the RFID circuit element To by the tape feeding roller 107).

Next, when the RFID circuit element To, which is the information readout target, is transported to the vicinity of the antenna 14, a “Scroll All ID” command for reading information stored in the RFID circuit element To is outputted to the signal processing circuit 22 in step S501. The signal processing circuit 22 generates a “Scroll All ID” signal as RFID tag information based upon the “Scroll All ID” command, and the “Scroll All ID” signal is transmitted to the RFID circuit element To from which information is to be read (hereinafter “target RFID circuit element To”) via the radio frequency circuit 21, prompting a reply.

Next, in step S502, the reply signal (information including ID information) transmitted from the target RFID circuit element To in response to the “Scroll All ID” signal is received via the antenna 14, and incorporated via the radio frequency circuit 21 and the signal processing circuit 22.

Next, in step S503, the decision is made as to whether or not the reply signal received in the above step S502 is erroneous using a known error detecting code [CRC (Cyclic Redundancy Check) code or the like].

In a case where the decision is made that the condition is not satisfied, the flow proceeds to step S504 where N is incremented by one. Then, in step S505, the decision is made as to whether or not N is equal to five. In a case where N is less than or equal to four, the decision is made that the condition is not satisfied and the flow returns to step S501 where the same procedure is repeated. In a case where N is equal to five, the flow proceeds to step S506 where an error display signal is outputted to the terminal 5 or general purpose computer 6 via the input/output interface 31 and communication line 3, and the corresponding reading failure (error) is displayed. Then, in step S507, the flag F is set to 1 and the routine ends. With such an arrangement, a maximum of five retries are performed even if information reading fails, thereby expending all possible means to ensure readout reliability.

In a case where the decision is made that the condition is satisfied in step S503, the reading of the RFID tag information from the target RFID circuit element To is completed, whereupon the routine ends.

With the above-described routine, the present modification makes it possible for the target RFID circuit element To within the cartridge to access and read the RFID tag information (tag ID information, etc.) stored in the IC circuit part 151.

(2) In a Case where the Storage Space is Designed with a Tilted Structure

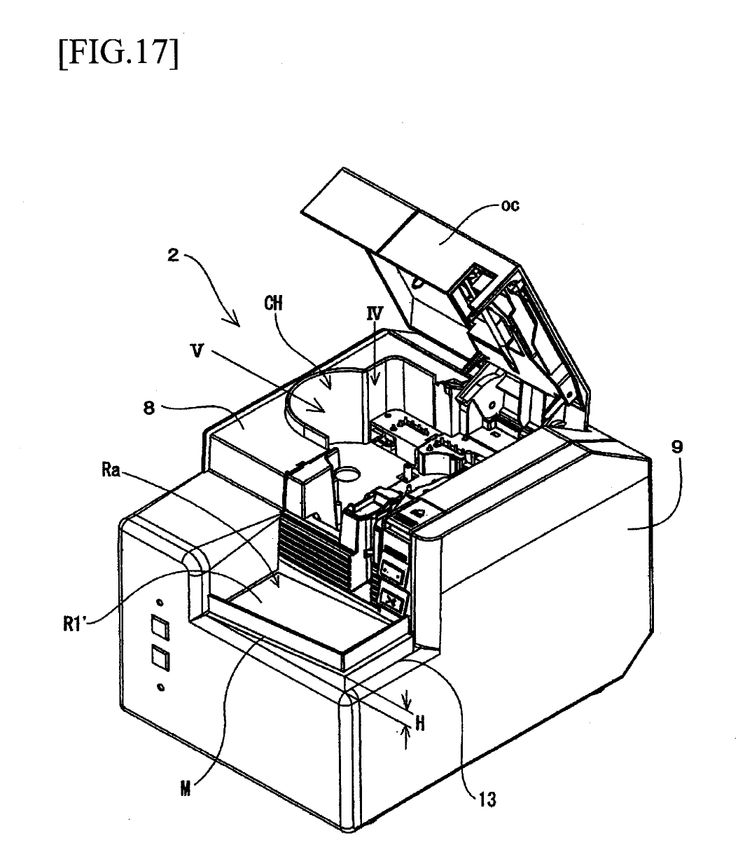

FIG. 17 is a perspective diagram which shows the overall general structure of an apparatus for communicating with a RFID tag according to the present modification, and corresponds to the above-described FIG. 2. Note that the parts identical to those in FIG. 2 are denoted using the same reference numerals, and descriptions thereof will be suitably omitted. In FIG. 17, the apparatus for communicating with a RFID tag of the present modification comprises a storage space Ra of a tilted structure. The storage space Ra is designed so that the right side in the figure is sufficiently raised a height H with respect to the plane 13 parallel to the lower surface of the housing 9, thereby forming the bottom shape, and comprises a collection surface R1′ (tilted bottom surface) sufficiently tilted at a predetermined angle on the left side in the figure.

In the present modification, the tag label T discharged from the carry-out exit E is tilted when discharged onto the collection surface R1′, thereby enabling storage in a state of alignment at the lower side of the tilt (left side in the figure). Of course, the tilting direction is selected based on the structure of the main body, and may be set toward the viewer or toward the right side in the figure. Further, the collection surface R1′ is disposed so that the printed character surface of the tag label T discharged from the carry-out exit E is facing upward.

(3) In a Case where the Storage Space is Designed with a Pull-Out Structure

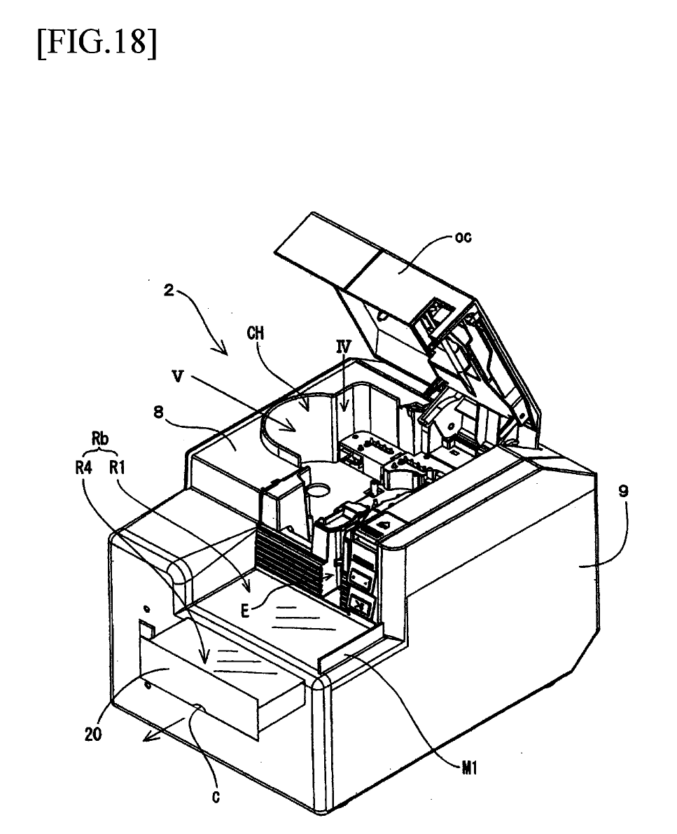

FIG. 18 is a perspective diagram which shows the overall general structure of an apparatus for communicating with a RFID tag according to the present modification, and corresponds to the above-described FIG. 2 and FIG. 17. Note that the parts identical to those in FIG. 2 are denoted using the same reference numerals, and descriptions thereof will be suitably omitted.

In FIG. 18, the apparatus for communicating with a RFID tag of the present modification comprises a storage space Rb of a pull-out structure. The storage space Rb comprises a substantially horizontal collection surface R1 provided on the front face of the carry-out exit E of the housing 9, a partition plate M1 provided to the border part of the collection surface R1, and a pull-out body R4 of a solid structure that can be pulled out from and pushed back into a concave part of the wall surface on the front face of the housing 9, and that has an upper part on substantially the same plane as (or slightly below) the collection surface R1. A front plate 20 configured to extend upward and downward and forms a circular-arc shaped notch part C at the bottom end, is provided on the front face of the pull-out body R4.

The RFID label T discharged from the carry-out exit E is collected on the collection surface R1 without falling owing to the partition plate M1 and, after passing from the upper face of the collection surface R1, is collected into the upper area of the pull-out body R4 without falling owing to the front plate 20 of the pull-out body R4 pulled out toward the front.

In the present modification, the pull-out body R4 is pulled out from the concave part of the housing 9 during use so as to store the RFID label T and placed into the housing 9 during non-use, making it possible to store a relatively large RFID label T without increasing the overall size of the apparatus (in other words, making it possible to prevent an increase in the overall size of the apparatus 2 when a relatively large RFID label T is to be stored, thereby enabling size reduction).

(4) In a Case where the Storage Space is Designed with a Rotational Flip-Up Structure

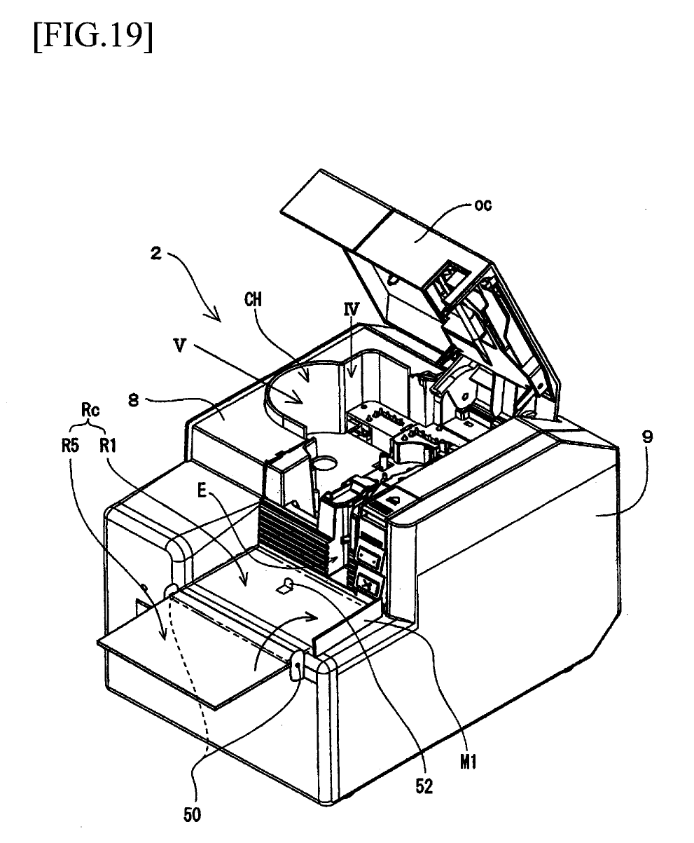

FIG. 19 is a perspective diagram which shows the overall general structure of an apparatus for communicating with a RFID tag according to the present modification, and corresponds to the above-described FIG. 2, FIG. 17, FIG. 18, etc. Note that the parts identical to those in FIG. 2 are denoted using the same reference numerals, and descriptions thereof will be suitably omitted. In FIG. 19, the apparatus for communicating with a RFID tag of the present modification comprises a storage space Rc of a rotational flip-up structure. The storage space Rc comprises, similar to the above, a substantially flat collection surface R1, the partition plate M1 provided to the border part of the collection surface R1, and a flip-up part R5 of a substantially thin-plate shape capable of approximately 180-degree rotation from a horizontal plane around a rotational axis 50, provided on the wall surface of the front face of the housing 9 slightly below the collection surface R1. When the storage space RC is not is use, the flip-up part R5 is rotated as described above so as to be supported by the upper surface of the collection surface R1. On the other hand, when the stack Rc is in use, the flip-up part R5 supported by the upper surface of the collection surface R1 is set in a substantially horizontal state by holding a tab 52 provided on the lower surface and rotating the flip-up part R5 approximately 180 around the rotational axis 50 In this state, the upper surface of the flip-up part R5 and the collection surface R1 are configured to be substantially on the same plane.

The RFID label T discharged from the carry-out exit E is collected on the collection surface R1 without falling owing to the partition plate M1 and, after passing over the upper surface of the collection surface R1, is collected on the flip-up part 5 maintained substantially horizontally.

In the present modification, the flip-up part R5 is set to a substantially horizontal state during use so as to store the RFID label T, and rotated around the rotational axis 50 and flipped upward during non-use, making it possible to store a relatively large RFID label T without increasing the overall size of the apparatus (in other words, making it possible to prevent an increase in the overall size of the apparatus 2 when a relatively large RFID label T is to be stored, thereby enabling size reduction).

(5) In a Case where the Storage Space is Designed with a Rotational Push-Down Structure

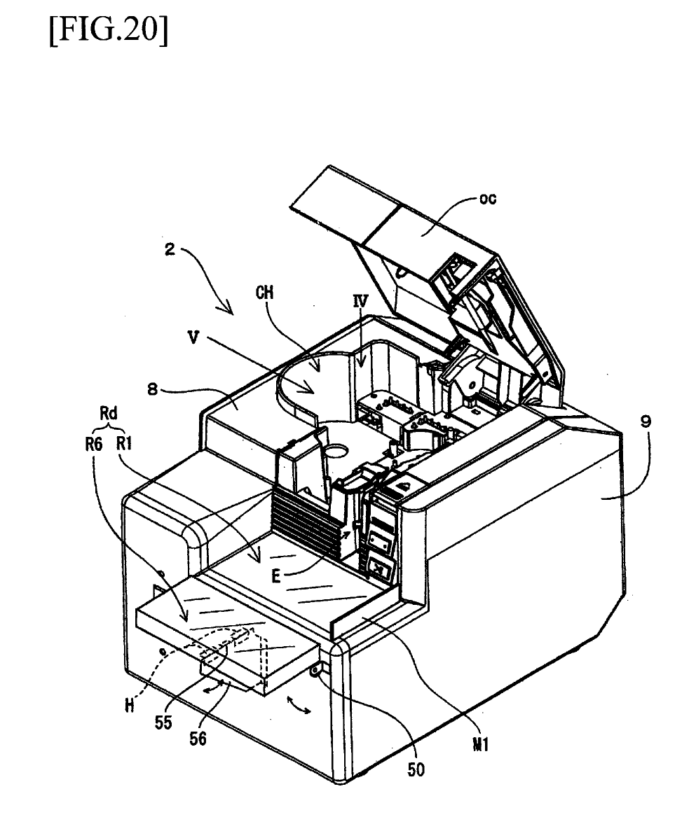

FIG. 20 is a perspective diagram which shows the overall general structure of an apparatus for communicating with a RFID tag according to the present modification, and corresponds to the above-described FIG. 2, FIG. 17, FIG. 18, FIG. 19, etc. Note that the parts identical to those in FIG. 2 are denoted using the same reference numerals, and descriptions thereof will be suitably omitted. In FIG. 20, the apparatus for communicating with a RFID tag of the present modification comprises a storage space Rd of a rotational push-down structure. The storage space Rd comprises, similar to the above, a substantially horizontal collection surface R1, a rectangular-shaped partition plate M1, and a push-down part R6 capable of being rotated approximately 90 degrees downward from a horizontal plane around the rotational axis 50, located on the wall surface of the front face of the housing 9 slightly below the collection surface 1. The push-down part R6 comprises a bracket 56 that can be folded approximately 90 degrees via a hinge H at the center of the lower surface. Further, a stopper 55 bent into an L-shape is provided at the upper end comprising the hinge H.

When the storage space Rd is not to be used, the push-down part R6 is rotated with the bracket 56 pushed down to the side of the push-down part R6 and folded until the lower surface thereof contacts the front face of the housing 9 as described above. On the other hand, when the push-down part R6 is to be used, the push-down part R6 is rotated approximately 90 degrees around the rotational axis 50 from a state of being pushed down to the front face of the housing 9, and set to a substantially horizontal state. In this state, when the bracket 56 is pushed down until it is orthogonal to the lower surface of the push-down part R6, the stopper 55 contacts the lower surface of the push-down part R6 and the bracket 56 contacts the front face of the housing 9 so as to maintain the push-down part R6 horizontally. Furthermore, in this state, the upper surface of the push-down part R6 and the collection surface R1 are configured to be substantially on the same plane.

The RFID label T discharged from the carry-out exit E is collected on the collection surface R1 without falling owing to the partition plate M1 and, after passing over the upper surface of the collection surface R1, is collected on the upper surface of the push-down part R6 maintained substantially horizontally.

In the present modification, the push-down part R6 is set to a substantially horizontal state during use so as to store the RFID label T, and rotated around the rotational axis 50 and pushed downward to the front face side of the housing 9 during non-use, making it possible to store a relatively large RFID label T without increasing the overall size of the apparatus (in other words, making it possible to prevent an increase in the overall size of the apparatus 2 when a relatively large RFID label T is to be stored, thereby enabling size reduction).

(6) In a Case where the Storage Space Itself is Designed with a Folding Structure

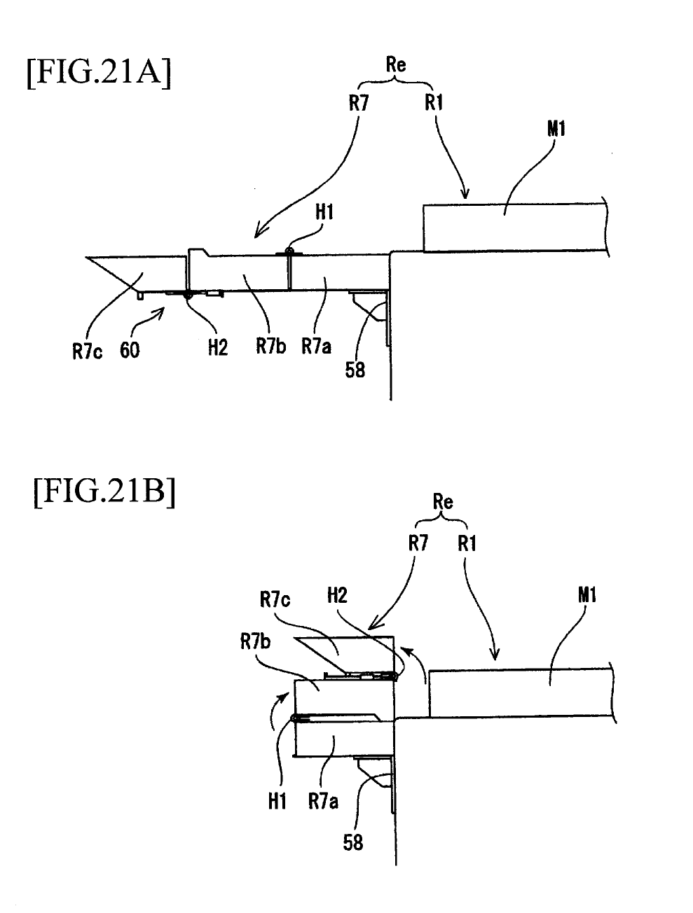

FIG. 21 is a side view which shows relevant components of the apparatus for communicating with a RFID tag according to the present modification. Note that the parts identical to those in FIG. 2 are denoted using the same reference numerals, and descriptions thereof will be suitably omitted. In FIG. 21A and FIG. 21B, the storage space Re of a folding structure is provided in the apparatus for communicating with a RFID tag of the present modification. The storage space Re comprises, similar to the above, the substantially horizontal collection surface R1, the rectangular-shaped partition plate M1, and a folding body R7 installed to the wall surface of the front face of the housing 9 slightly below the collection surface R1.

The folding body R7 is designed in three parts comprising a rear anchor R7a installed via a bracket 58 on the vertical wall surface of the front face of the housing 9, an intermediate part R7b connected via a hinge H1 to the upper end of the rear anchor R7a, and an end part R7c connected via a hinge H2 to the lower end of the intermediate part R7b. A support member 60 configured to support the lower surface of the end part R7c in a horizontal state is provided to the lower surface of the intermediate part R7b in a slidable manner with respect to the lower surface of the end part R7c.

When the folding body R7 is to be used, as shown in FIG. 21A, the end part R7c is rotated via the hinge H2 and the intermediate part R7b is rotated via the hinge H1 so that the lower end of the intermediate part R7b contacts the lower end of the rear anchor R7a. The support member 60 is then slid and extended so as to support the lower surface of the end part R7c. With such an arrangement, the entire folding body R7 is extended substantially horizontally. In this state, the upper surface of the folding body R7 and the collection surface R1 are configured to be substantially on the same plane.

The RFID label T discharged from the carry-out exit E is collected on the collection surface R1 without falling owing to the partition plate M1 and, after passing over the upper surface of the collection surface R1, is collected on the upper surface of the folding body R7 maintained substantially horizontally.

When the folding body R7 is not to be used, as shown in FIG. 21B, first, with the support member 60 slid back to the lower surface of the intermediate part R2b, the end part R7c is rotated counterclockwise via the hinge H2 and the intermediate part R7b is rotated clockwise via the hinge H1 so as to compactly support the end part R7c and the intermediate part R7b in a folded state on the upper surface of the rear anchor R7a.

In the present modification, the folding part R7 is extended to a substantially horizontal state as shown in FIG. 21A during use so as to store the RFID label T, and set to a folded state as shown in FIG. 21B during non-use, making it possible to store a relatively large RFID label T without increasing the overall size of the apparatus (in other words, making it possible to prevent an increase of the overall size of the apparatus 2 when a relatively large RFID label T is to be stored, thereby enabling size reduction).

(7) A Case where the Storage Space is Designed with a Vertical Storage Structure (Drop-Down Structure)

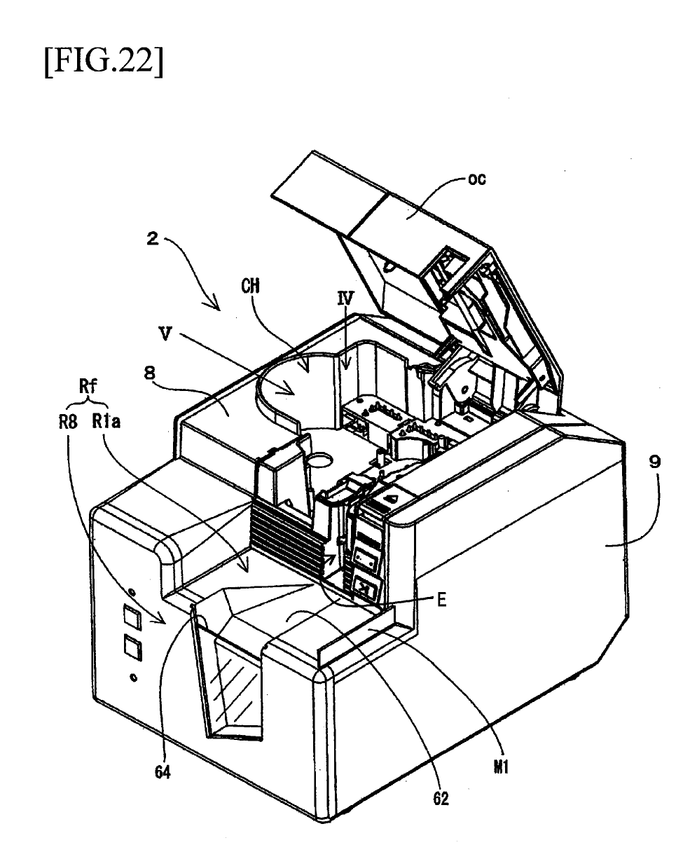

FIG. 22 is a perspective diagram which shows the overall general structure of an apparatus for communicating with a RFID tag according to the present modification, and corresponds to the above-described FIG. 2, FIG. 17, FIG. 18, FIG. 19, FIG. 20, etc. Note that the parts identical to those in FIG. 2 are denoted using the same reference numerals, and descriptions thereof will be suitably omitted. In FIG. 22, the apparatus for communicating with a RFID tag of the present modification comprises a storage space Rf of a vertical storage structure. The storage space Rf comprises, similar to the above, the substantially horizontal collection surface R1a, the rectangular-shaped partition plate M1, a tilted concave part 62 tilted toward the discharging direction (downward left direction in the figure) of the RFID label T from the collection surface R1, and a storage space R8 provided to the wall surface of the front face of the housing 9, continuing to the tilted concave part 62. Further, a lid body 64 of a transparent resin plate, for example, is provided to the front side of the storage space R8.

The RFID label T discharged from the carry-out exit E is collected on a collection surface R1a without falling owing to the partition plate M1 and, after passing over the upper surface of the collection surface R1a, is guided into the tilted concave part 62, changed to a downward direction so that the end part in the discharging direction faces substantially downward, dropped into the storage space R8, and stored with the tape (label) longitudinal direction in a substantially vertical direction. The tilted concave part 62 tilted toward the discharging direction (downward left direction in the figure) of the RFID label T from the collection surface R1a is disposed so that the printed surface of the tag label T discharged from the carry-out exit E faces upward.

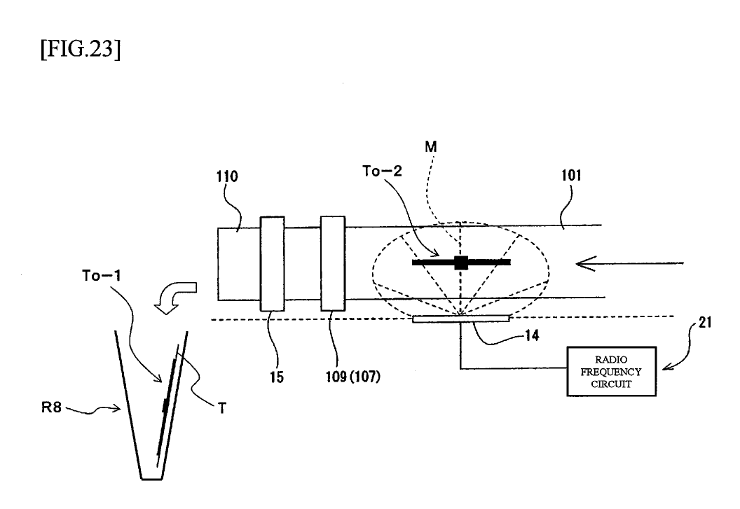

FIG. 23 is an explanatory diagram which conceptually shows from the side the positional relationship of the antenna 14, the feeding path of the tape 101, etc., and the storage space R8 of the storage space Rf of the present modification, and corresponds to the above-described FIG. 15. In FIG. 22 and FIG. 23, the base tape 101 after the IC circuit part 151 is accessed as described above is adhered to the print-receiving tape 103 between the tape feeding roller 107 and sub-roller 109 so as to form a single tape. The tape thus formed is then fed in the direction denoted by the arrow in the figure, transported along the feeding path as the tag label tape 110 with print, cut by the cutter 15 so as to be formed into the RFID label T (including the RFID circuit element To-1) of a predetermined length, and stored in the storage space R8 of the storage space Rf.

At this time, the storage space Rf is positioned below the antenna 14 and the feeding path of the tapes 101, 110, etc., so as to be in a direction not in line with the main lobe direction M of the antenna 14. Particularly, in the present modification, the RFID label T discharged in a substantially horizontal direction from the carry-out exit E is rotated downward and stored within the storage space R8, thereby setting the polarization plane direction of the antenna 152 of the RFID circuit element To-1 disposed in the longitudinal direction of the tag label T to a substantially vertical direction (substantially vertical direction in the FIG. 23). As a result, the polarization plane direction (a substantially horizontal direction; the substantially downward left direction in FIG. 23) of the antenna 152 and the polarization plane direction of the antenna 14 disposed in a substantially horizontal direction are mutually different (no longer become mutually parallel), resulting in a low mutual antenna gain and a decrease in the strength of the through signal, making it possible to prevent without fail erroneous access of the RFID circuit element To-1 from the antenna 14.

(8) In a Case where the Storage Space is Designed with a Post-Installable Structure

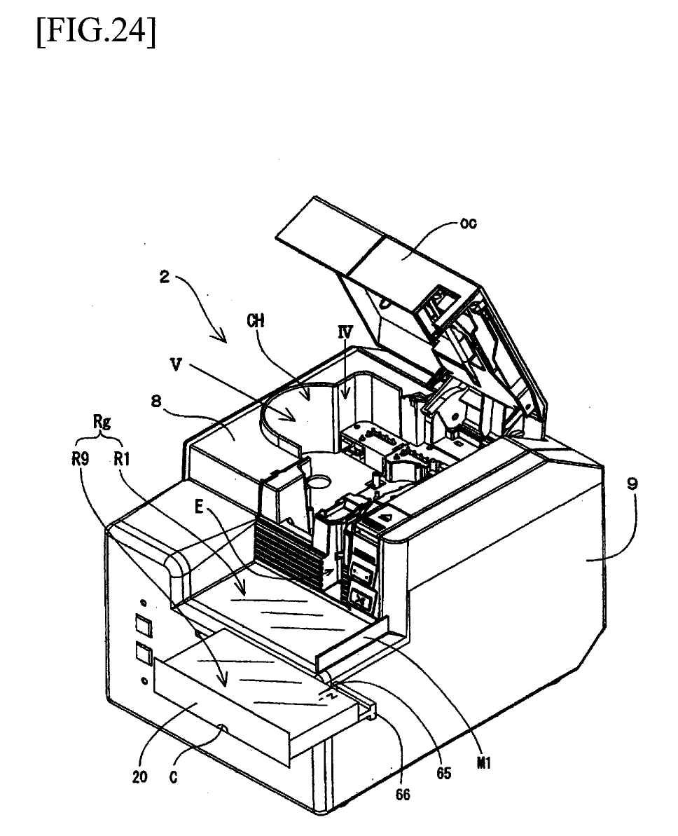

FIG. 24 is a perspective diagram which shows the overall general structure of an apparatus for communicating with a RFID tag according to the present modification, and corresponds to the above-described FIG. 2, FIG. 17, FIG. 18, FIG. 19, FIG. 20, etc. Note that the parts identical to those in FIG. 2 are denoted using the same reference numerals, and descriptions thereof will be suitably omitted. In FIG. 24, the apparatus for communicating with a RFID tag of the present modification comprises a storage space Rg of a post-installable structure. The storage space Rg comprises, similar to the above, the substantially horizontal collection surface R1, the rectangular-shaped partition plate M1, a guiding groove 65 formed substantially horizontally on the wall surface of the front face of the housing 9 slightly below the collection surface R1 of the housing 9 so that one end part is free, and a post-installation part R9 of a solid structure that comprises a joining part 66 configured to detachably join to the guiding groove 65. The front face of the post-installation part R9 comprises a front plate 20 configured to extend vertically and forms the notch part C of a circular arc shape at the lower end part. The upper surface of the post-installation part R9 and the collection surface R1 of the housing 9 are configured to be substantially on the same plane.

When the storage space Rg is to be used, the entire post-installation part R9 is maintained at the wall surface of the front face of the housing 9 by sliding and inserting the joining part 66 at the rear end of the post-installation part R9 into the free end of the guiding groove 65 until the joining part 66 becomes even with the housing 9 side wall. The RFID label T discharged from the carry-out exit E is collected on the collection surface R1 without falling owing to the partition plate M1 and, after passing over the upper surface of the collection surface R1, is collected on the upper surface of the post-installation part 9 maintained substantially horizontally. When the storage space Rg is not to be used, the joining part 66 of the post-installation part R9 is pulled out from the guiding groove 65 by sliding the post-installation part R9 in the reverse direction.

In the present modification, the post-installation part R9 is installed to the wall surface of the front face of the housing 9 during use so as to store the RFID label T discharged from the carry-out exit E, and removed from the wall surface of the front face of the housing 9 during non-use, making it possible to store a relatively large RFID label T without increasing the overall size of the apparatus (in other words, making it possible to prevent an increase in the overall size of the apparatus 2 when a relatively large RFID label T is to be stored, thereby enabling size reduction). Further, the apparatus main body 8 and the post-installation part R9 are designed as separate bodies, thereby improving user-friendliness at the time of transport, storage, and other handling.

(9) Other

(9-A) Structure Omitting the Collection Surface

While the collection surface R1 or R1a is provided in each of the above-described modifications (3) to (8) respectively described using FIG. 18, FIG. 19, FIG. 20, FIG. 21, FIG. 22, and FIG. 24, the collection surface R1 or R1a does not necessarily need to be provided and may be omitted. In such a case, the RFID label T discharged from the carry-out exit E is introduced to and maintained in the pull-out body R4, flip-up part R5, push-down part R6, folding body R7, storage space R8, and post-installation part R9 as is. In each of these cases as well, the same effect is achieved.

(9-B) In a Case where a Shielding Material is Used

The storage space R described in the present embodiment and each of the modifications may be constructed using a shielding material configured to reduce the strength of the radio communication signal. In this case, the material of the storage space itself is provided with a radio wave shielding function, thereby further preventing without fail erroneous access of the RFID circuit element To of the RFID label T within each storage space R from the antenna 14. With such an arrangement, the entire storage space does not need to be constructed using the shielding material. Rather, simply the side (surface) near the antenna may be constructed using the shield material, that is a metal, conductive material, radio wave absorbent material such as ferrite, or a resin containing a conductive material or a radio wave absorbent material.

(9-C) Variations of the Antenna Main Lobe Direction, Feeding Direction, Storage Direction, Etc.

While in the above the feeding direction of the base tape 101, print-receiving tape 103, etc., is positioned in the substantially horizontal direction, the feeding path of the base tape 101 is positioned in the main lobe direction M of the antenna 14, which is upward from the antenna 14, and each storage space R (particularly, the collection surface) is positioned below the antenna 14, the present invention is not limited thereto.

That is, the structure may correspond to a design wherein the overall form of the apparatus 2 for communicating with a RFID tag is modified while all positional relationships of the above-described tape feeding direction, main lobe direction of the antenna 14, the storage space R position, and the antenna 14 position are left as is.

For example, with a structure in which a surface 9A of the housing 9 in the perspective view shown in FIG. 2 is set as the bottom surface, the feeding direction of the base tape 101 is in a substantially vertical direction, the feeding direction of the print-receiving tape 103, etc., is first in a substantially vertical direction and then a substantially horizontal direction (with the tape width direction in a substantially horizontal direction as well), the antenna 14 is disposed with the surface direction in a substantially vertical direction, the feeding direction of the base tape 101 is positioned in the main lobe direction M, which is in a substantially horizontal direction (opposite a surface 9B), and each storage space R (particularly the collection surface) is positioned farther toward the surface 9B than the antenna 14. Furthermore, in this case, the RFID label T discharged from the carry-out exit E is configured so that the surface direction thereof is pressed upward to the surface 9B (in other words, to the collection surface) so as to maintain the surface direction of the storage space Ra, Rb, Rc, Rd, and Rg in a substantially vertical direction. With the storage space Rf, the surface direction of the RFID label T is further pressed around to the storage space 64 so as to maintain the surface direction of the storage space R8 in a substantially vertical direction.

Or, with a structure in which a surface 9C of the housing 9 in the perspective view shown in FIG. 2 is set as the bottom surface, the feeding direction of the base tape 101, etc., is in a substantially vertical direction, the feeding direction of the print-receiving tape 103, etc., is first in a substantially horizontal direction and then in a substantially vertical direction, the antenna 4 is disposed with the surface direction in a substantially vertical direction, the feeding path of the base tape 101 is positioned in the main lobe direction M, which is in a substantially horizontal direction (opposite a surface 9D), and each storage space R (particularly the collection surface) is positioned farther toward the surface 9D than the antenna 14. Furthermore, in this case, the RFID label T discharged from the carry-out exit E in the downward vertical direction is configured so that the surface direction thereof is pressed to the surface 9D (in other words, to the collection surface) so as to maintain the surface direction of the storage space Ra, Rb, Rc, Rd, and Rg in a substantially vertical direction. With the storage space Rf, the surface direction of the RFID label T is further pressed around to the storage space 64 so as to maintain the surface direction of the storage space R8 in a substantially vertical direction.

In each of the above examples as well, the same effect as described above is achieved. What matters is that the storage space R is disposed from the antenna 14 in a direction other than the main lobe direction M thereof.

(9-D) In a Case where Adherence is not Performed, Etc.

Further, while in the above a method in which print is printed on the print-receiving tape 103 separate from the base tape 101 comprising the RFID circuit element To and subsequently the print-receiving tape 103 and the base tape 101 are adhered to each other is employed, the present invention is not limited thereto and may be applied to a method in which print is printed on the print-receiving tape contained in the tag tape (a method where adherence is not performed). Furthermore, the present invention is also not limited to a case where the RFID tag information is read from or written to the IC circuit part 151 of the RFID circuit element To, and print for identifying the RFID circuit element To is printed by the print head 10. This printing does not necessarily need to be performed, and the present invention may be applied to a case where RFID tag information is only read or written.

(9-E) Other Tape Shapes, Etc.

Furthermore, while in the above a case where the tag tape is wound around a reel member so as to form a roll, and the roll is disposed within the cartridge 100, and hence the tag tape is fed out from the cartridge has been described as an example, the present invention is not limited thereto. For example, an arrangement can be made as follows. Namely, a long-length or rectangular tape or sheet (including tape cut to a suitable length after being supplied from a roll) in which at least one RFID circuit element To is disposed is stacked in a predetermined storage space so as to form a cartridge. The cartridge is then mounted to the cartridge holder provided to the apparatus 2 for communicating with a RFID tag. Then, the tape or sheet is supplied or fed from the storage space, and printing or writing is performed, thereby creating tag labels.

Furthermore, the cartridge method is not limited thereto. Also, an arrangement can be made that the roll is attached directly to the apparatus 2 for communicating with a RFID tag, or the long-length or rectangular tape or sheet is transported from outside the apparatus 2 for communicating with a RFID tag sheet by sheet by a predetermined feeder mechanism and supplied to the apparatus 2 for communicating with a RFID tag. In each of these cases as well, the same effect as the above-described embodiment is achieved.

Note that the “Scroll ALL ID” signal, “Erase” signal, “Verify” signal, “Program” signal, “Kill” signal, and “Sleep” signal used in the above embodiment are compliant to specifications enacted by EPC global. EPC global is a nonprofit corporation co-established by EAN (European Article Number) International, which is an international distribution code organization, and the Uniform Code Council (UCC), which is an American distribution code organization. Note that any signals compliant with other standards can be employed as long as the signals provide the same functions.

Note that various modifications which are not described in particular can be made according to the present invention without departing from the spirit and scope of the invention.

What is claimed is:

1. An apparatus for communicating with a RFID tag comprising:
a housing including a carry-out exit;
an apparatus-antenna device configured to perform radio communication with an IC circuit part of a RFID circuit element and to have a directivity, said RFID circuit element being provided to a tape-shaped or sheet-shaped tag medium and including a tag antenna and said IC circuit part, said apparatus-antenna device being installed on said housing;
a feeding device configured to feed said tag medium to said carry-out exit; and
a storage space configured to store said tag medium discharged from said carry-out exit by said feeding device after said radio communication is performed from said apparatus-antenna device, a storage space being disposed in a direction other than a direction of a main lobe of said apparatus-antenna device from said apparatus-antenna device.

2. An apparatus for communicating with a RFID tag according to claim 1, wherein:
said storage space is disposed in a null direction of said apparatus-antenna device.

3. An apparatus for communicating with a RFID tag according to claim 1, wherein:
said apparatus-antenna device is disposed so that at least one part of a feeding path of said tag medium by said feeding device intersects said direction of main lobe.

4. An apparatus for communicating with a RFID tag according to claim 3, wherein:
said storage space is disposed so that its heightwise position is below the heightwise position of said apparatus-antenna device on condition that at least the feeding direction of the feeding path of said tag medium in a position face to said apparatus-antenna device is set to the horizontal direction and the width direction of said tag medium is set to the vertical direction.

5. An apparatus for communicating with a RFID tag according to claim 4, wherein:
said storage space is disposed so that its heightwise position is below said carry-out exit.

6. An apparatus for communicating with a RFID tag according to claim 4, wherein:
said apparatus-antenna device is a planar antenna.

7. An apparatus for communicating with a RFID tag according to claim 6, wherein:
said storage space is disposed to a position below an emitting surface for radio waves of said planar antenna as viewed from said planar antenna.

8. The apparatus for communicating with a RFID tag according to claim 4, wherein:
said storage space comprises a tilted bottom surface tilted sufficiently at a predetermined angle from the horizontal direction so as to put said tag medium on, said tag medium being discharged to outside said housing from said carry-out exit.

9. The apparatus for communicating with a RFID tag according to claim 4, wherein:
said storage space is disposed so that at least one part thereof can appear and disappear in a substantially horizontal direction from an area near said carry-out exit of said housing.

10. The apparatus for communicating with a RFID tag according to claim 4, wherein:
said storage space is disposed so that at least one part thereof can be rotated around a rotational axis positioned near said carry-out exit of said housing.

11. The apparatus for communicating with a RFID tag according to claim 4, wherein:
said storage space is fixed to an area near said carry-out exit of said housing, and at least one part thereof is foldably constructed.

12. The apparatus for communicating with a RFID tag according to claim 4, wherein:
said storage space stores said tag medium discharged in a substantially horizontal direction from said carry-out exit and rotated downward so that the end part in the discharge direction is set substantially downward.

13. The apparatus for communicating with a RFID tag according to claim 1, wherein:
said storage space is configured so that a direction of polarization plane of said RFID circuit element provided to said stored tag medium and a direction of polarization plane of said apparatus-antenna device differ with each other.

14. The apparatus for communicating with a RFID tag according to claim 1, wherein:
said storage space is configured so that at least one part thereof is detachably provided to said housing.

15. The apparatus for communicating with a RFID tag according to claim 1, wherein:
at least a section of said storage space disposed approximate to said apparatus-antenna device is constructed by a shielding material configured to reduce the strength of a radio communication signal.

16. The apparatus for communicating with a RFID tag according to claim 1, further comprising a printing device configured to print predetermined print on said tag medium fed by said feeding device or a print-receiving medium adhered to said tag medium.

17. The apparatus for communicating with a RFID tag according to claim 1, wherein:
said storage space is positioned at a distance within one wavelength of the communication radio wave from said apparatus-antenna device.
